(19) United States
(12) Patent Application Publication
(10) Pub. No.: US 2026/0081782 A1
(43) Pub. Date: Mar. 19, 2026

(54) COMPUTING SYSTEMS AND METHODS FOR PROVISIONING PRIVACY-PRESERVING IDENTITY-BOUND PASSKEYS AND DIGITAL SIGNATURES

(71) Applicant: Login ID Inc., San Mateo, CA (US)

(72) Inventors: Simon LAW, San Mateo, CA (US); Yuriy ACKERMANN, Tauranga (NZ); Teng WU, Waterloo (CA); Peter Thien DUONG, Mississauga (CA)

(73) Assignee: Login ID Inc., San Mateo, CA (US)

(21) Appl. No.: 19/328,075

(22) Filed: Sep. 12, 2025

Related U.S. Application Data
(60) Provisional application No. 63/694,412, filed on Sep. 13, 2024.
(60) Provisional application No. 63/745,782, filed on Jan. 15, 2025.

(51) Int. Cl. H04L 9/32; H04L 9/08

(52) U.S. Cl. CPC H04L 9/3231; H04L 9/0894

(57) ABSTRACT

Systems and methods are provided that allows users to execute a secure digital action that is authenticated by their digital wallet app (or wallet) on a user device or a wallet server. An identity issuer server issues a batch of verification credentials (VCs) for an identity holder to the wallet. The wallet stores the batch of VCs, respectively binds each VC in the batch of VCs with a given passkey from a plurality of passkeys, generates selective disclosures via a content generator server, and transmits the batch of VCs, as a plurality of VC presentations, to an identity verification server. An identity verification server requests and validates the plurality of VC presentations, and, responsive to validating the plurality of VC presentations, registers the plurality of device-bound passkeys respectively bound to the batch of VCs to generate a plurality of registered passkeys. In a secure digital action, after generating the plurality of registered passkeys, the identity verification server is further configured to authenticate the identity holder using one or more of the registered passkeys.

### CROSS-REFERENCE TO RELATED APPLICATIONS

This patent application claims priority to U.S. Provisional Application No. 63/694,412 filed on Sep. 13, 2024 and titled “COMPUTING PLATFORM CENTRIC WALLET SYSTEMS FOR IDENTITY SHARING AND RELATED METHODS”, and to U.S. Provisional Application No. 63/745,782 filed on Jan. 15, 2025 and titled “COMPUTING SYSTEMS AND METHODS FOR PROVISIONING PRIVACY-PRESERVING IDENTITY-BOUND PASSKEYS AND DIGITAL SIGNATURES”, the entire contents of which are hereby incorporated by reference.

### TECHNICAL FIELD

The following generally relates to computing systems and methods for provisioning a privacy-preserving identity-bound passkey and applying the same to generate a privacy-preserving identity-bound digital signature.

### DESCRIPTION OF THE RELATED ART

Physical identities (IDs), such as plastic driving license, passport, etc., are widely used to prove the identities. As technologies advance, people start to tackle some inherent problems of physical IDs. In some cases, the below one or more technical problems are encountered with existing computing systems and devices in relation to physical IDs, including their use for digital systems.

Identity theft: Anyone, who steals the physical ID or even a copy of the ID, may be able to impersonate the victim. The identity thief can open bank accounts or credit cards on behalf of the victim.

Excessive information disclosure: Physical IDs usually have excessive information on them. For example, when a person shows the driving license to an alcohol store to prove his/her age, the name, address are also disclosed to the store.

Forged ID: Though anti-counterfeiting measures are implemented, forging a physical ID is still possible.

Online use: Physical IDs are not designed for online use. To verify physical IDs online, very complicated processes are implemented to ensure the authenticity of the presented photo copies of physical IDs.

When people were exploring digital IDs to resolve the problems of physical ID, the verifiable credential concept was introduced as an instance of digital ID. There are two widely accepted specifications/standards that realized the verifiable credential concept: W3C specification of Verifiable Credential (VC), and ISO standard of Mobile driving license (mDL).

In some cases, the digital IDs can resolve the problems mentioned above. Take W3C VC as one example.

Identity theft: The presentation of VC is based on public key cryptography. Instead of showing the ID to the identity verifier, the identity holder will use the private key associated with this VC to sign a message. Then the identity verifier can extract the public key from the VC and verify the signature. The private key usually is protected well and can be used only when the identity holder approves it. In this case VCs serve as a digital certificate, which renders the identity theft impossible.

Excessive information disclosure: VC offers a way called selective disclosure to avoid disclosing excessive information. The identity holder can choose to show age only without revealing the name and address. There are two ways to implement this selective disclosure: a cryptography way and a non-cryptography way.

In a cryptography process, the identity holder gets a full VC from the identity issuer. The VC contains all information, such as age, name, address. Instead of presenting this VC, the identity holder generates a cryptographic proof to prove that the age is from a valid VC which is signed by the identity issuer without revealing the whole VC. This mechanism is based on advanced cryptography called zero-knowledge proof. In some cases, the cryptography processes use a BBS digital signature scheme, which is categorized as a form of short group signature that supports several unique properties. BBS supports signing multiple messages whilst producing a single output digital signature. Through this capability, the possessor of a signature is able to generate proofs that selectively disclose subsets of the originally signed set of messages, whilst preserving the verifiable authenticity and integrity of the messages. Furthermore, these proofs are said to be zero-knowledge in nature as they do not reveal the underlying signature; instead, what they reveal is a proof of knowledge of the undisclosed signature. BBS digital signature is named after its creators, cryptographers Dan Boneh, Xavier Boyen, and Hovav Shacham.

In a non-cryptography way. the identity issuer issues VC per attribute to the identity holder. The identity attribute is one piece of information of the whole identity. For example, age, name, address are three identity attributes. In this case, the identity holder can select which attributes to disclose.

Forged ID: The forger has to break all the cryptography protections implemented in order to forge a VC. Those cryptography protections are proved to be secure enough, which renders the forgery impractical.

Online use: VC is intrinsic to be used online.

Though the digital IDs, such as mDL or VC, solved some of the problems of physical IDs, in some cases, digital IDs are still facing multiple technical challenges.

### SUMMARY

The following summary is intended to introduce the reader to various aspects of the detailed description, but not to define or delimit any invention.

In at least one broad aspect, a system is provided that comprises a user device, an identity issuer server, an identity verification server, and a content generator server. The identity issuer server is configured to issue a batch of verification credentials (VCs) for an identity holder to an identity wallet application installed on the user device. The identity wallet application is configured to store the batch of VCs, respectively bind each VC in the batch of VCs with a given device-bound passkey from a plurality of device-bound passkeys, generate selective disclosures via the content generator server, and transmit the batch of VCs, as a plurality of VC presentations, to the identity verification server, wherein the identity wallet application transmits the plurality of VC presentations responsive to receiving a consent action from the identity holder. The identity verification server is configured to request and validate the plurality of VC presentations, and, responsive to validating the plurality of VC presentations, register the plurality of device-bound passkeys respectively bound to the batch of VCs to generate a plurality of registered passkeys. After generating the plurality of registered passkeys, the identity verification server is further configured to authenticate the identity holder using one or more of the registered passkeys. The content generator server is configured to prepare digital content and transmit the digital content to the identity wallet application. After receiving the digital content, the identity wallet application is configured to further attach one or more VCs of the batch of VCs to the digital content and digitally sign a combination of the attached one or more VCs and the digital content using one or more of the plurality of passkeys corresponding to the attached one or more VCs. In some cases, the one or more passkeys used to sign the combination of the attached one or more VCs and the digital content are one or more registered passkeys.

In some cases, the identity verification server is a subsystem comprising a verifier module and a Fast Identity Online (FIDO) server, the verifier is configured to generate and transmit VC presentation requests, and the FIDO server is configured to store and manage public keys.

In some cases, the user device comprises biometric authentication hardware to authenticate the identity holder and release access to one or more private keys for signing, the one or more private keys corresponding to the one or more public keys.

In some cases, the system further comprises a public witness network configured to store mappings of VCs and passkeys.

In some cases, the public witness network comprises distributed databases or a blockchain network of databases.

In some cases, the user device comprises biometric authentication hardware to authenticate the identity holder and release access to private keys for signing.

In some cases, presenting the VCs is triggered by at least one of: scanning a QR code, near-field communication (NFC), and Bluetooth.

In some cases, the identity wallet application is further configured to generate a new device-bound passkey responsive to detecting that no match is found in a list of known passkeys.

In some cases, the identity wallet application is further configured to manage both the VCs and the passkeys.

In some cases, the identity wallet application is further configured to manage the VCs, while a passkey manager is configured to manage the passkeys.

In at least another broad aspect, a system is provided comprising a wallet server, an identity issuer server, an identity verification server, and a content generator server. The identity issuer server is configured to issue a batch of VCs, for an identity holder, to a cloud-based identity wallet application on the wallet server, the cloud-based identity wallet application accessible through a user device of the identity holder. The cloud-based identity wallet application is configured to retrieve insurance metadata, respectively bind each VC in the batch of VCs with a passkey from a plurality of passkeys, generate selective disclosures via the content generator server, and transmit the batch of VCs, as a plurality of VC presentations, to the identity verification server, wherein the identity wallet application transmits the plurality of VC presentations responsive to receiving a consent action from the identity holder. The identity verification server is configured to request and validate the plurality of VC presentations, and, responsive to validating the plurality of VC presentations, register the plurality of passkeys respectively bound to the batch of VCs to generate a plurality of registered passkeys. After generating the plurality of registered passkeys, the identity verification server is further configured to authenticate the identity holder using one or more of the registered passkeys. The content generator server is configured to prepare digital content and transmit the digital content to the identity wallet application. After receiving the digital content, the identity wallet application is configured to further attach one or more VCs of the batch of VCs to the digital content and digitally sign a combination of the attached one or more VCs and the digital content using one or more of the plurality of passkeys corresponding to the attached one or more VCs. In some cases, the one or more passkeys used to sign the combination of the attached one or more VCs and the digital content are one or more registered passkeys.

In some cases, the identity verification server comprising a verifier module and a FIDO server, the verifier module is configured to generate and transmit VC presentation requests, and the FIDO server is configured to store and manage one or more public keys.

In some cases, the user device comprises biometric authentication hardware to authenticate the identity holder and release access to one or more private keys for signing, the one or more private keys corresponding to the one or more public keys.

In some cases, the system further comprises a public witness network configured to store mappings of VCs and passkeys.

In some cases, the public witness network comprises distributed databases or a blockchain of network.

In some cases, presenting the VCs is triggered by any one of: scanning a QR code, NFC, and Bluetooth.

In some cases, the identity wallet application is further configured to generate a new device-bound passkey responsive to detecting that no match is found in a list of known passkeys.

In some cases, the identity wallet application is further configured to manage both the VCs and the passkeys.

In some cases, the identity wallet application is further configured to manage the batch of VCs, while a passkey manager is configured to manage the passkeys.

In at least another broad aspect, a computing device is provided comprising: a processor, a display, memory and a communication module; the memory storing a software application for an identity wallet; wherein the software application is configured to: display a credential issuance request and a VC presentation request in response to an external data call; generate a VC presentation; execute a passkey selection to select an existing passkey that is bound to the computing device or to generate a new passkey that is bound to the computing device; append the existing passkey or the new passkey to the VC presentation request and is signed by a corresponding VC; and send the VC presentation in response to the external data call.

According to some aspects, the present disclosure provides a non-transitory computer-readable medium storing computer-executable instructions. The computer-executable instructions, when executed, configure a processor to perform any of the methods described herein.

### BRIEF DESCRIPTION OF THE DRAWINGS

Embodiments will now be described by way of example only with reference to the appended drawings wherein:

FIG. 1 is a schematic diagram of a system of computing servers and devices in of a unified system architecture (also called unified architecture);

FIG. 2 is a schematic diagram of a separated system architecture (also called separated architecture);

FIG. 3 is a flow diagram for a VC passkey binding process for a unified architecture;

FIG. 4 is another flow diagram for a VC passkey binding process for a unified architecture;

FIG. 5 is a flow diagram for a VC passkey binding process for a separated architecture;

FIG. 6 is a flow diagram for VC passkey binding for a separated architecture;

FIG. 7 is a flow diagram for VC batching;

FIG. 8 is another flow diagram for VC batching;

FIG. 9 is a flow diagram of a process with a public witness network;

FIG. 10 is a system diagram is provided for executing VC synchronization;

FIG. 11 is a flow diagram of a registration process;

FIG. 12 is a flow diagram of user authentication using augmented PAKE;

FIG. 13 is a flow diagram of the content generator registration process;

FIG. 14 are a flow diagram for content signing;

FIG. 15 is a flow diagram for platform-generated VC attributes;

FIG. 16 is another flow diagram for platform-generated VC attributes;

FIG. 17 is a flow diagram for a process for using a cloud-based wallet;

FIG. 18 is another flow diagram for a process for using a cloud-based wallet;

FIG. 19 is another flow diagram for a process for using a cloud-based wallet;

FIG. 20 is another flow diagram for a process for using a cloud-based wallet;

FIG. 21 is a diagram to explain a structure of the various systems and features;

FIG. 22 is a schematic diagram of an example of a system of user device; and

FIG. 23 is a schematic diagram of components of a server.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures and components have not been described in detail so as not to obscure the example embodiments described herein. Also, the description is not to be considered as limiting the scope of the example embodiments described herein.

In some cases, the Verifiable Credential (VC) is used as an example to demonstrate our solution. However, in some cases, the proposed systems, devices and methods described herein can work with other types of digital IDs.

In some cases, a technical issue that is addressed herein is the long-term use of the verified identity. VC is not designed for daily use. For example, every time a user buys alcohol from an online alcohol store, he/she will be redirected to the identity wallet and present a VC to prove his/her age. Compared with authentication, this redirected identity proving process is cumbersome and frictional. The systems, devices and methods described herein address this issue, such that proving identity is as simple as authentication.

When designing a solution to solve the long-term use problem, in some cases, the systems, devices and methods described herein include the following one or more (or all three) of the below features.
1. Unlinkability: The reuse of the same VC will result in the violation of privacy. Consider the following example. The identity holder presents the same VC to different merchants' websites. Anyone, who can observe the presentation of this VC to multiple merchants, may link all the accounts to the same person.
2. Bidirectional undeniability: The undeniability of VC is unidirectional. The identity holder can never deny the presentation of a VC. However, the verifier can deny the receipt of a VC. Usually, there is no witness to the VC presentation, who can prove the receipt of the VC presentation.
3. Synchronizability: Synchronizing VCs across multiple devices involves securely synchronizing cryptography keys through an untrusted cloud environment. Synchronization of VCs is valuable because the identity wallet application may be Web based, which doesn't have reliable local storage. In the Web case, the VCs can only be stored on the cloud and synchronized to the browser local storage every time the identity holder signs in.

In some cases, an application of this long-term usable verified identity is online content signing. In existing systems, the online content signing (e.g., in some cases available under the trade name DocuSign) doesn't have a verified identity attached to the signed content. Therefore, there is a chance that the signer can deny. In some cases, with a verified identity attached to the signed content, the signature is more trustworthy.

### Glossary

Verifiable Credentials (VCs)—refer to cryptographically secure, tamper-proof digital statements used for identity sharing. They allow individuals to prove information about themselves or entities in a trustworthy and privacy-preserving manner. VCs are issued by an authority and stored in a digital wallet. In some cases, to share a credential, the holder creates a Verifiable Credential Presentation, which enables selective disclosure of information while maintaining security and privacy.

Verifiable Credential Presentation (VCP)—refers to a cryptographically secure package created by the holder of a Verifiable Credential to share specific information with a verifier. It allows the holder to selectively disclose only the necessary details from their credential while maintaining data integrity and privacy. In some cases, the presentation is signed by the holder to prove ownership of the credential and to ensure it has not been tampered with, enabling trust and verification in digital interactions.

Mobile Document (mDoc)—refers to a digital version of a physical document, such as an ID card, passport, or driver's license (mDL), securely stored on a mobile device. In some cases, similar to Verifiable Credentials (VCs), mDocs enable users to share verified information in a secure, privacy-preserving manner. They are device-bound, cryptographically protected, and, in some cases, comply with international standards like ISO/IEC 18013-5. mDocs support selective disclosure, allowing individuals to share only the necessary details for specific interactions, such as verifying age or residency without revealing additional personal information.

Mobile Driver's License (mDL)—refers to a digital version of a physical driver's license stored securely on a mobile device, functioning similarly to Verifiable Credentials (VCs). It serves as an official identification document, enabling individuals to share verified information, such as age or identity, in a secure and privacy-preserving manner. Like VCs, mDLs are issued by a trusted authority, comply with international standards (such as ISO/IEC 18013-5), and support selective disclosure, allowing users to share only the necessary details for a specific purpose, such as proving their age without revealing their full address. A subset of mDoc ISO standards.

VC Passkey—refers to a wallet and device-bound, non-exportable cryptographic key linked to specific Verifiable Credentials, enabling secure, seamless, and privacy-preserving authentication and identity verification.

Cloud-Based Identity Wallet—refers to a digital wallet hosted in the cloud, used to manage and store Verifiable Credentials and other digital identities.

Platform/Trusted Platform—refers to an ecosystem provider that governs and manages the underlying technology stack. Examples include Google for Android, Apple for iOS, iPadOS, and macOS, and Microsoft for Windows. The trusted platform, in some cases, includes a secure enclave, a secure element, and a trusted execution environment.

Zero-Knowledge Proof (ZKP)—is a cryptographic method where one party proves to another that a statement is true without revealing any additional information beyond the validity of the statement.

Augmented Password Authenticated Key Exchange (PAKE)—refers to a protocol for secure password-based authentication and key exchange that ensures passwords are never transmitted or stored in plaintext.

Hardware Security Module (HSM)—refers to a physical device or cloud-based system that provides secure generation, storage, and management of cryptographic keys.

Selective Disclosure—refers to a mechanism allowing users to share only specific pieces of information from a larger dataset (e.g., verifying age without revealing name or address).

Device Attestation—refers to a process by which a platform verifies the authenticity and integrity of a device to ensure it meets specific security standards.

Public Key Cryptography (PKC)—refers to a cryptographic system that uses a pair of keys: one public (shared) and one private (kept secret). It's used in authentication, encryption, and digital signatures.

Ephemeral Wallet Public Key—refers to a temporary cryptographic key generated by a digital wallet to securely interact with an identity issuer or verifier.

Batch API—refers to an Application Programming Interface (API) that allows the issuance of multiple Verifiable Credentials in a single request.

Device-Bound Credential—refers to a cryptographic key or credential linked to a specific device, ensuring it cannot be used on any other device.

Identity Proofing—refers to a process of verifying an individual's identity through documents, biometrics, or other credentials.

Attestation Information—refers to data provided by a platform or device to prove its authenticity and compliance with security standards.

### Overview

### Devices, Modules and Roles in the System

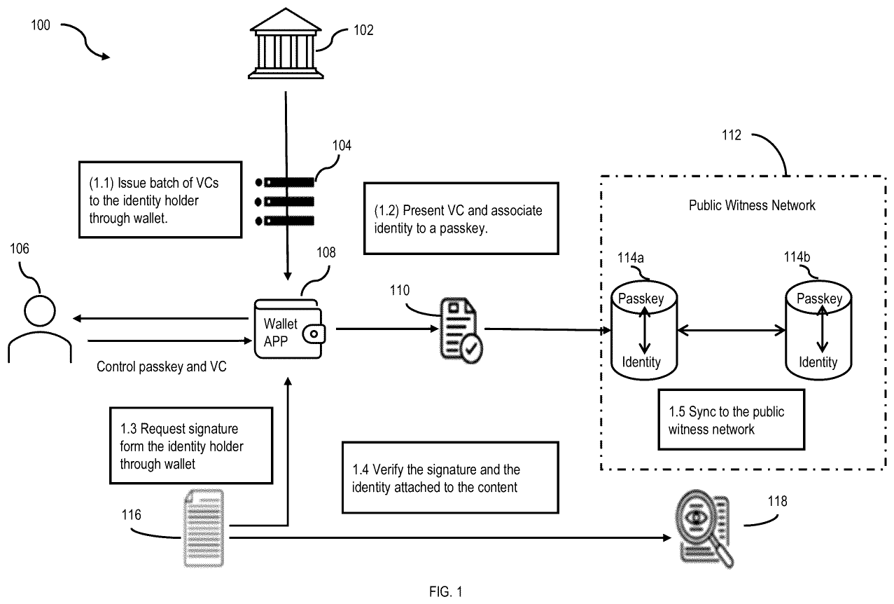

Referring to FIG. 1, a unified system 100 is provided showing and the operations of various devices, modules and roles.

Identity issuer 102 (server system): The identity issuer 102 is an identity authority who issues identity proof (VC) to the identity holders. For instance, government can be an intrinsic identity issuer. Other entities, such as banks and mobile operators, can also be identity issuers. In some cases, the identity issuer 102 is also herein called an identity issuer server.

Identity holder 106: The identity holder (also called “user”) is the subject of the identity. In some cases, the identity holder can be a person.

Identity verifier 110 (server system): The identity verifier verifies the identity. Anyone can be an identity verifier. For example, an alcohol store is an identity verifier who verifies the age of its customers. In some cases, the identity verifier is also herein called an identity verification server.

Identity wallet application 108 (also called “wallet”, “identity wallet app”, or “identity wallet”, and installed in a computing device operable by identity holder 106): This is a software application that manages all the issued VCs for the identity holder. It can be a native mobile application (or APP), a desktop application, or a web application. The identity wallet application 108 can help the identity holder to apply and store the VCs. It can also present the VCs to the identity verifier or sign content for the identity holder. In some cases, all the operations need approval from the identity holder. In some cases, a mobile device or a desktop device, or some other computing device, stores and executes the identity wallet.

Trusted platform 104 (server system): The manufacturer of the hardware or the provider of the operating system can be the trusted platform 104. The trusted platform 104 serves as a “firewall” between the identity issuer 102 and identity wallet application 108. In some cases, it enforces that only the identity requests from valid devices can reach the identity issuer. In some cases, the trusted platform 104 can provide more information about the device, such as attestation information.

Content generator 116 (server system): The content generator 116 generates the content to be signed. For example, the online merchant generates the user service agreement and lets the user sign it. In some cases, the content generator 116 is a component, as well as a verification schema, within the identity wallet application 108 that is responsible for creating selective disclosures from a verifiable credential. It allows the wallet to break down a credential (e.g., a digital driver's license) into individual pieces of information (e.g., age, address, and name) and share only the specific information that a verifier needs to see. For example, if a wine merchant only needs to know that an identity holder 106 is over 19 years old for legal compliance, the content generator 116 enables the identity wallet application 108 to provide just that information without revealing the full birthdate and other personal details of the identity holder 106. In some cases, the content generator 116 is also herein called a content generator server.

Content verifier 118 (server system): The content verifier 118 is responsible for checking the validity and authenticity of the information that has been selectively disclosed by the content generator 116. The content generator 116 can also be the content verifier 118. In the example above, the online merchant server will verify the signed user service agreement after the user signs it. The content verifier 118 works in conjunction with other components including the identity wallet application 108, the content generator 116, and the identity issuer 102, to ensure that the disclosed data is accurate and trustworthy. In some cases, the content verifier 118 is also herein called a content verifier server. In some cases, the convent verifier and the content generator are modules operating together on a same server.

Public witness network 112: The public witness network 112 is run by the organization other than identity holders or identity verifiers. The wallet can be the owner of this network. Or another independent third party can be the owner of this network. In some cases, this network provides witness of passkey and identity mapping. It can also provide the signature witness. In the event of dispute between identity holders and identity verifiers, this network will provide trustworthy records. Specifically, the public witness network 112 is a system containing multiple databases where information about verification credentials is published to establish trust. Two of these databases are shown for illustrative purposes: database 114a and database 114b. The public witness network 112 allows an identity verifier 110 (such as a merchant or organization) to cross reference and confirm that a credential presented by the identify holder 106 is legitimate and was issued by a trusted identity issuer 102. The public witness network 112 can be run and controlled by different entities, such as the provider of the identity wallet application 108, the identity issuer 102 (e.g., government agency), or a public blockchain. Its main purpose is to make the verification process transparent and trustworthy, so that identity verifier can check that a credential is signed by the correct passkey or authority.

It will be appreciated that the above server systems each include a processor, memory and a communication module (e.g., a network interface) to interact with other servers and computing devices. The computing device that is operable by an identity holder includes a mobile device or a computing desktop, which includes a processor, memory, a communication module, and input/output devices configured for user interaction or viewing. In some cases, the computing device includes hardware and software for a biometric authenticator (e.g., face scanner, thumbprint scanner, other biometric scanner).

### High Level Description

At (1.1), the identity issuer 102 issues a batch of identity proof VCs to the identity holder 106 through the identity wallet application 108, as well as the trusted platform 104, which serves as a “firewall” between the identity issuer 102 and identity wallet application 108. The VCs can be cryptographically signed and stored in the identity wallet application 108. In some cases, to make the verified identity suitable for long-term use, the verified identity 110 is associated with a passkey. In some cases, each VC in the batch of VCs is configured for a single use. The initial set-up includes redirecting the user to the identity wallet in order to present the VC. In some cases, after the VC and passkey are associated, as long as the user is authenticated by this passkey, the identity is implicitly verified. For long-term, verifying identity is as simple as signing in using passkey. In some cases, the identity holder 102 is able to control passkeys and VCs via the identity wallet application 108.

To offer unlinkable VCs, in some cases, the identity issuer issues a batch of VCs to the identity holder at one time. In some cases, each VC is disposable to avoid reusing VCs. Therefore, a single used VC (e.g., a VC that has already been used in a verification computation) is inherently unlinkable.

When an identity verifier 110 (e.g., a merchant or service provider) requests proof of certain information, at (1.2), the system 100 presents VCs and associate the verified identity 100 to a passkeys. Then at (1.3), the content generator 116 that requests signature for the content to be signed from the identity holder 106, and at (1.4), the content verifier 118 verifies the signature and the identity attached to the content. In this way, the identity wallet application 108, via the content generator 116 and content verifier 118, prepares the appropriate information for disclosure.

In some cases, the content generator 116 is configured to prepare digital content (e.g., selective attributes about the identity holder) and transmit the digital content to the identity wallet application. After receiving the digital content, the identity wallet application is configured to further attach one or more VCs of the batch of VCs to the digital content and digitally sign a combination of the attached one or more VCs and the digital content using one or more passkeys corresponding to the attached one or more VCs. In some cases, the one or more passkeys used to sign the combination of the attached one or more VCs and the digital content are one or more registered passkeys that have been registered with the identity verification server (also called the identity verifier 110).

In case the identity verifier 110 denies the receipt of VCs, a public accessible database is introduced. At 1.5, the VC presentations and mapping between VCs and Passkeys are synchronized and stored in the database. The database can be managed by a trusted third party. In some other cases, a public blockchain database is used to maintain a trusted database. In some cases in which there is a dispute, everyone can verify the VC presentations and mapping between VCs and passkeys (e.g., or a given VC and a given passkey).

In some cases, synchronizing VCs across multiple devices through an untrusted cloud is achieved by applying Augmented PAKE protocol. The VCs are encrypted by a cryptography key derived from the user's password and stored on the cloud. In order to synchronize the stored VCs, the user has to authenticate to the cloud using the password. To prevent the server from knowing the password, the Augmented PAKE is applied here to enable the cloud authenticating the user using the password without knowing the password.

In some cases, this passkey can also be used for signing content. The signed content is associated with this verified identity through the binding of the passkey and the VC.

### System Architecture

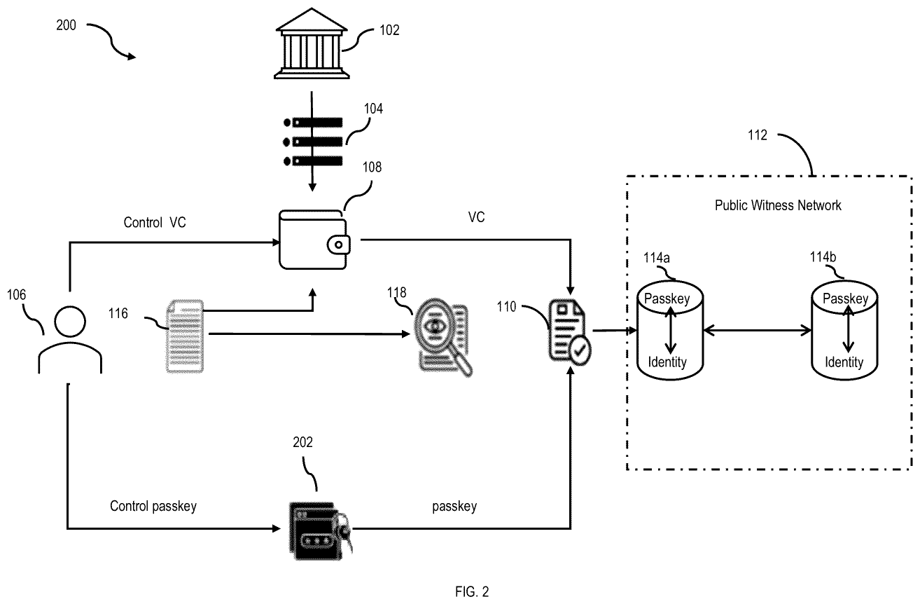

In some cases, there are two settings of the computing system. The first setting is that the wallet manages both passkeys and VCs. The second setting is that the wallet manages the VCs only, and passkeys are managed by the passkey manager. The former one is called unified architecture and the latter one is called separated architecture. The difference between unified architecture and separated architecture is demonstrated in FIGS. 1 and 2. FIG. 1 shows a unified system 100 architecture. FIG. 2 shows a separated system 200 architecture. The difference between the separated system 200 and the unified system 100 is that the separated system incorporates a passkey manager application 202 to manage passkeys separately while the identify wallet application 108 manages the VCs.

Examples of trusted platforms include: hardware and software available under the trade names Google Android, Apple iOS or Mac OS or watch OS, Samsung, and/or related computing hardware elements.

Examples of an identity wallet application 108 (also called “wallet”, “identity wallet app”, or “identity wallet”) include those available under the trade names Google Wallet, Apple Wallet, Samsung Wallet, Paze, and Paypal Wallet.

In at least some embodiments, a computing device is provided that includes a software application (e.g., an identity wallet app). In some cases, the computing device is a mobile device. In some cases, the computing device includes biometric authentication hardware. In some cases, the computing device operates in a unified system architecture that includes other computing devices (e.g., servers). In some cases, the computing device operates in a separated system architecture that includes other computing devices (e.g., servers).

In at least some embodiments, a server system is provided that operates as a platform (e.g., a trusted platform) that receives data from an identity issuer. In some cases, the server system operates in a unified system architecture that includes other computing devices (e.g., mobile devices and/or servers). In some cases, the server system operates in a separated system architecture that includes other computing devices (e.g., mobile devices and/or servers).

In at least some embodiments, a system is provided that includes: a server system is provided that operates as a platform (e.g., a trusted platform) that receives data from an identity issuer; a computing device, which includes a software application (e.g., an identity wallet app); and the server system and the computing device communicate with each other. In some cases, the system is a unified system architecture that includes other computing devices (e.g., mobile devices and/or servers). In some cases, the system is a separated system architecture that includes other computing devices (e.g., mobile devices and/or servers).

In some cases, there are systems that provision and bind a VC without the use of the identity wallet app.

### Identity-Bound Passkey

### VC Passkey Binding

In some cases, to improve the technical benefits of Digital Identity and solve the long-term use problem, the digital identity is effectively reused and securely bound. This can be achieved by associating it with a passkey or credential. For unified architecture and separated architecture, the binding is different. In some cases, the unified architecture gives full control over both passkeys and VCs to the wallet. Therefore, it can offer a higher identity assurance level. Compared with the unified architecture, in some cases the separated architecture provides a more flexible deployment and sacrifices the identity assurance level. In this section, the processes of binding VCs to passkeys for both settings are discussed.

### Unified Architecture

Because the wallet in the unified system 100 has full control over both passkeys and VCs, it can associate VCs with device-bound passkeys or device-bound credentials to improve the identity assurance level. This association is implemented by signing over the credential's JavaScript Object Notation (JSON) Web Key (JWK) attribute using a VC. A JWK is a JSON data structure that represents a cryptographic key. The binding happens inside the wallet. The wallet can utilize the secure hardware to assist the process, which makes theft and phishing virtually infeasible.

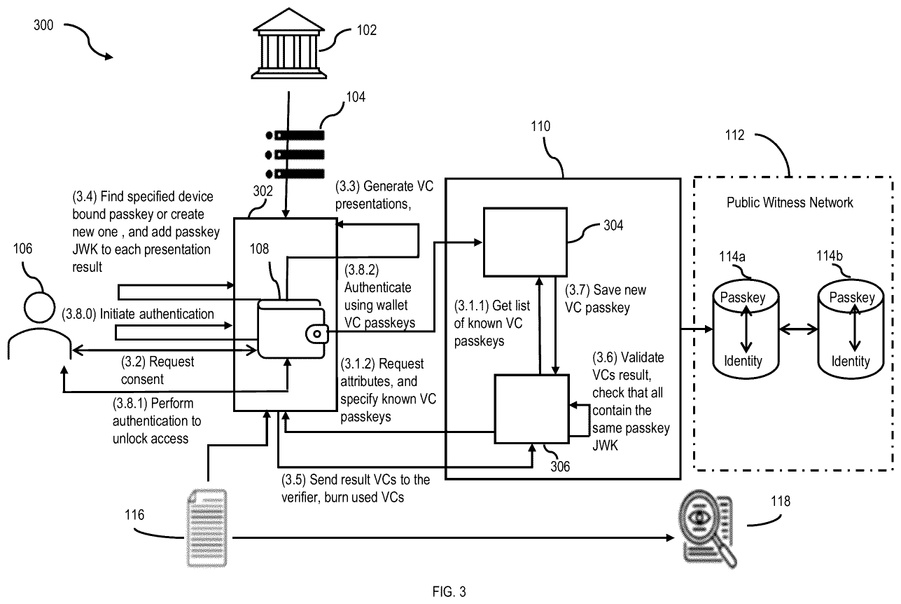

In some cases of a technical Implementation, FIG. 3 shows a flow diagram of data for VC Passkey Binding, according to the Unified System 300 Architecture. The wallet 108 can be on the same device as the verifier's APP, or on a different device. If the wallet APP and verifier APP are one the same device, this process can be triggered by redirect or inter process communication. If the wallet and verifier APPs are on different devices, QR code, NFC, Bluetooth can be used to trigger the process. In some cases, this process is triggered by scanning the QR code. Below are operations described in FIG. 3.
1. User Authentication or Account Creation:
   At (3.1.1). If an identity holder 106 operates their user device to log in to their existing account at verifier.example.com, the VC presentation request includes a list of known VC passkeys, referred to as allowedPasskeys. The Fast Identity Online (FIDO) server 304, which is a component of the identity verifier module 110, manages and stores public keys associated with allowedPasskeys.
   At (3.1.2). If an identity holder 106 operates their user device to create a new account at verifier.example.com, the verifier module 306, which, in some cases, is part of the identity verifier module 110, proceeds without a predefined list of allowedPasskeys.

In the meantime, the verifier module 306 invokes the native VC issuing API, either with the list of allowedPasskeys or without it.
2. User Consent: At (3.2), the wallet 108 displays a consent form requesting approval from the identity holder 106 for credential issuance and presentation.
3. VC Presentation Generation: At (3.3), upon the approval from the identity holder 106, the wallet 108 generates a VC presentation response for each required attribute.
4. Passkey Selection: At (3.4), the wallet 108 searches its internal storage for the first available passkey matching the allowedPasskeys list. If no match is found, then the wallet generates a new device-bound, non-exportable public key. If a match exists, then the wallet selects the existing public key. The wallet appends the selected public key to each VC presentation request as a JWK, with the kid (key ID) set to the credential ID, and is signed by the corresponding VC.
5. Presentation Submission: At (3.5), the wallet 108 sends the successfully created VC presentations to the verifier module 206. The used VCs are permanently destroyed (burned) in the wallet to prevent tracking, ensuring that each VC is used only once.
6. Verification: At (3.6), the verifier module 206 validates all received VCs, ensuring they include the same passkey JWK.
7. VC Passkey Registration: At (3.7), The verifier module 206 adds the JWK to its list of recognized VC passkeys. The FIDO server 304 saves the new VC passkey (e.g., the JWK).
8. Authentication: The user can then authenticate using this passkey and perform high-assurance operations, such as document signing. At (3.8.0), the wallet 108 initiates or requests authentication from the user device 302. Step (3.8.1) is the authentication (e.g., biometric or general) of the identity holder 106 on the user device 302. For example, the user device 302 (e.g., smart phone) prompts the identity holder 106 to perform biometric authentication using a device authenticator, such as scanning their face or fingerprint) to unlock access to the secure element or private key stored on the device 302. This ensures that only the legitimate user can proceed.

At (3.8.2), after successful authentication, the wallet 108 uses the now accessible private key to sign the passkey and any required data. It then sends this signed information to the FIDO server 304 for authentication.

This process enables the relying party (RP) to leverage FIDO credentials for various operations, such as recurring transactions, step-up authentication, no-KYC verification, document signing, and more. The RP can rely on the registered VC as proof that any user-signed transactions are directly linked to the VCs it has issued. In some cases, in a secure digital action for the RP, after an identity verification server generates the registered passkeys, the identity verification server is further configured to authenticate the identity holder using one or more of the registered passkeys.

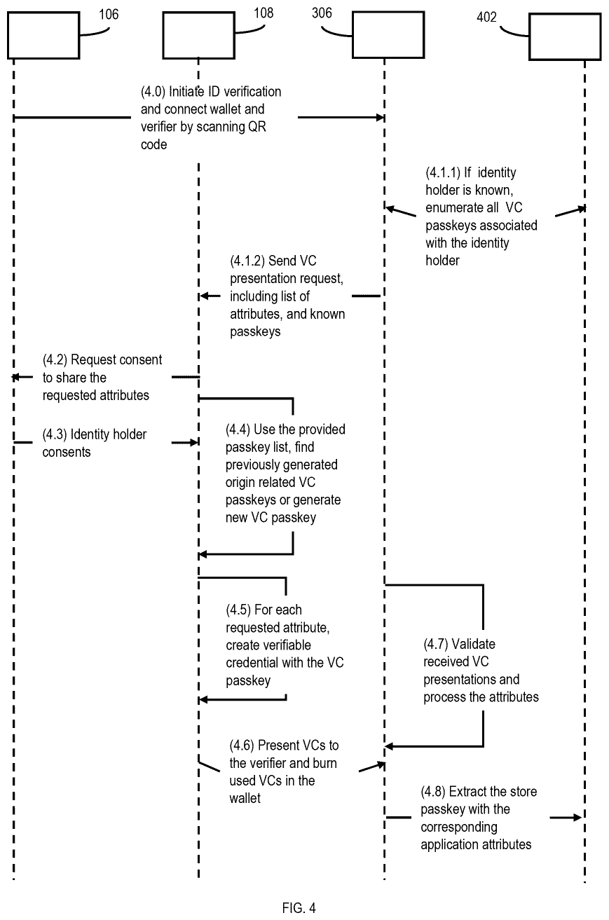

FIG. 4 is a sequence diagram of VC Passkey Binding Process for the Unified System Architecture. At (4.0), the identity holder 106 initiates ID verification and connects wallet 108 and verifier 306 by scanning QR code. At (4.1.1) If the identity holder is known, the passkey server 402 enumerates all VC passkeys associated with the identity holder. At (4.1.2), the verifier 306 send VC presentation request, including list of attributes and known passkeys, to the wallet 108. At (4.2), the wallet 108 request consent from the identity holder 106 to share the requested attributes. At (4.3), the identity holder consents the request. At (4.4), the wallet 108 uses the provided passkey list, finds previously generated origin related VC passkeys or generates new VC passkey. At (4.5), for each requested attribute, the wallet 108 creates verifiable credential with the VC passkey. At (4.6), the wallet presents VCs to the verifier 306 and burns used VCs in the wallet. At (4.7), the verifier 306 validates received VC presentations and process the attributes. At (4.8), the verifier 306 extracts the store passkey with the corresponding application attributes.

### Separated System Architecture

Not all the identity wallets want to manage passkeys for the identity holder 106. It is valuable to have the flexibility of decoupling the identity management and the passkey management. If the identity and passkey management are decoupled, the identity wallet doesn't have any control over the passkey. Therefore, in some cases, the binding cannot be done inside the wallet 108. The coordination between the identity wallet and the passkey manager is needed. It will lower the identity assurance level.

In some cases, a public witness network is provided as a remediation to a phishing possibility. Because this witness network is publicly accessible, the identity holder will notice if the identity is phished. Therefore, the identity holder 106 can immediately revoke the identity. The details of the public witness network 112 will be discussed in a later section.

In some cases, this solution is applied for low assurance scenarios. For high assurance scenarios, in some cases, the unified architecture is applied.

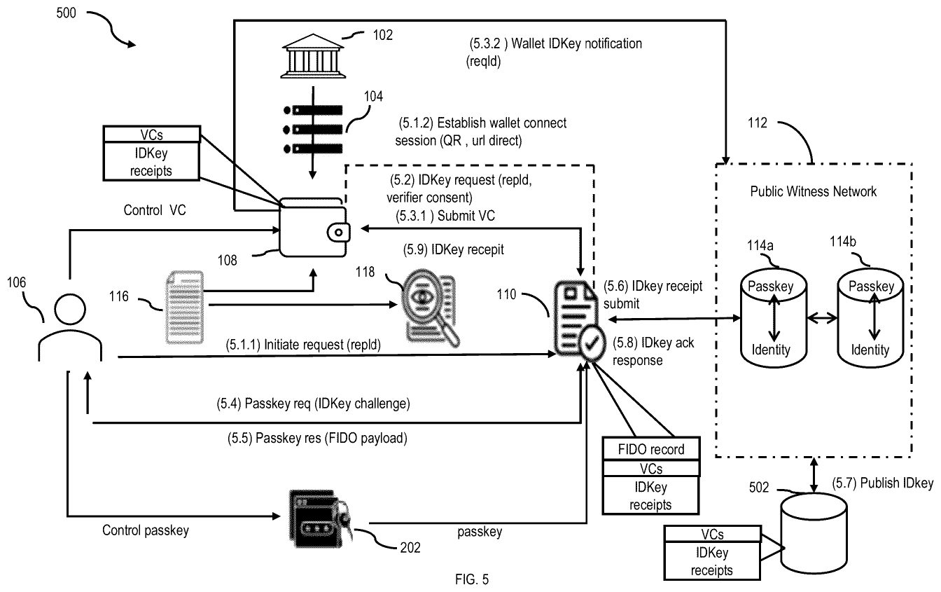

In some cases of a technical implementation, FIG. 5 shows a process for VC passkey binding for the Separated System 500 Architecture. At (5.1.1). the identity holder 106 initiates identity-bound passkey (IDKey) uses browser Webauthn passkey (e.g., iCloud, Google Manager, 1password). At (5.1.2), the system establishes wallet connect session (e.g., QR, url direct). At (5.3.1), the wallet 108 submits VC to the identity verifier 110. At (5.3.2), the wallet sends wallet IDKey notification to the public witness network. At (5.4), the identity verifier sends passkey request (IDKey challenge) to the identity holder 106. At (5.5), the identity holder 106 sends passkey response (FIDO payload) to the identity verifier 110. At (5.6) the identity verifier 10 submits IDKey receipt to the public witness network 112. At (5.7), the public witness network 112 publishes the IDKey, which is stored in the IDKey metabase 502. At (5.8), the public witness network 112 transmit IDKey acknowledge response to the identity verifier 110.

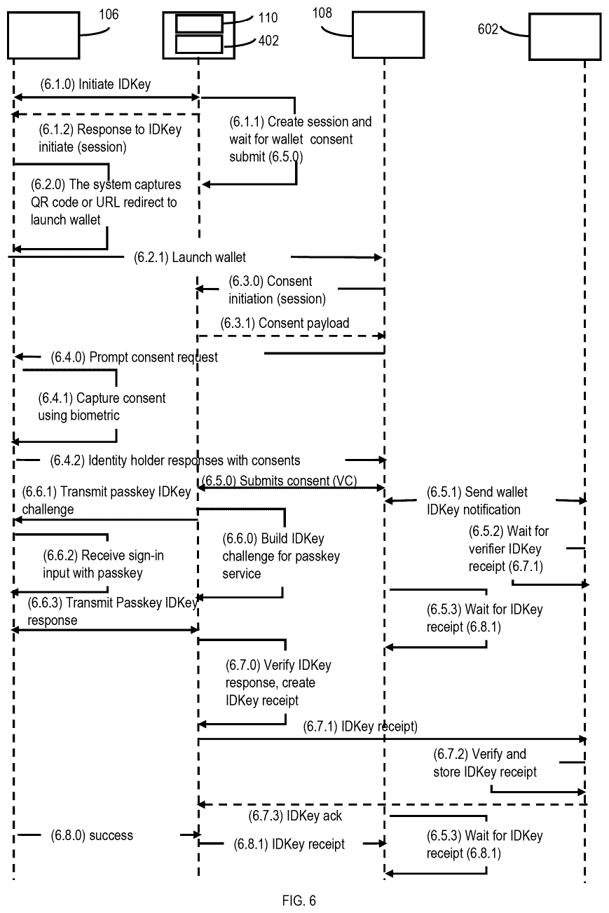

Referring to FIG. 6, a computing process for VC Passkey Binding is provided for the Separated System Architecture.

At (6.1.0), the identity holder initiates identity-bound passkey creation with the identity verifier. At (6.1.1), the identity verifier 110 creates new session to keep track of this creation process waits for the identity holder 106 to submit identity (VC) from wallet 108. At (6.1.2), the identity verifier 110 presents options (QR, url) for the identity holder 106 to connect to this session with wallet 108.

At (6.2.0) The system can capture QR code if wallet app 108 is not on same device or use url for same device. At (6.2.1), the identity holder 106 launches the wallet 108. At (6.3.0), the wallet connects to identity verifier 110 to initiate identity verification consent. At (6.3.1), the identity verifier 110 returns type of VC request and user consent to create IDKey

At (6.4.0), the wallet prompts consent from the identity holder 106 to the identity verifier 110 requesting for the release of VC stored on wallet, permission to link passkey with it, and scope of this IDkey i.e. transaction signing, document signing. At (6.4.1), the identity holder 106 unlocks wallet secure storage with biometric to access VC on wallet At (6.4.2), the identity holder 106 sends consent back.

At (6.5.0), the wallet submits VC to the identity verifier 110. At (6.5.1), the wallet sends IDkey create notification to ID Service Directory 602. At (6.5.2), the ID Service Directory 602 stores wallet notification and waits for IDKey receipt from the identity verifier 110 (7.1). At (6.5.3), the wallet 108 waits for IDKey receipt from the identity verifier 110 (8.1).

At (6.6.), the identity verifier 110 build IDKey challenge payload for Webauthn creation option for new passkey or Webauthn request option for existing passkey

IDKey challenge:
{
reqId: request id,
vcId: verifiable credential id,
vcHash: verifiable credential hash,
iat: issue at timestamp in unix-second format,
scopes: IDKey scopes (signing, txConf),
}

At (6.6.1), the identity verifier 110 sends Webauthn payload to user browser, At (6.6.2), the system receives passkey created or signed by the identity holder 106 and submits result payload to identity verifier 110. At (6.6.3) the response is sent back.

At (6.6.0), the identity verifier 110 validates and generates IDKey receipt as proof.

IDKey receipt
{
reqId: request id
vc: verifiable credential
challenge: IDKey challenge
fidoPayload: attestation or assertion payload
verifier: origin of verifier (domain)
scopes: IDKey scopes
}

At (6.7.1) the identity verifier sends IDKey receipt to ID Directory Service. At (6.7.2), the ID service directory 602 stores the record. At (6.7.3) the ID service directory 602 sends acknowledge confirmation after successful storing the receipt for IDKey public metabase 502.

At (6.8.0), the identity verifier 110 notifies the identity holder 106 of success. At (6.8.1), the identity verifier return IDKey receipt to wallet 108 (6.5.0) for record keeping of successful IDKey creation. At (6.8.2), the wallet 108 stores the receipt.

### Privacy-Preserving VC Batching (Unlinkability Property)

In an existing Verifiable Credential (VC) model, a single VC acts as a digital replacement for a physical ID, such as a driving license. However, this approach presents a significant privacy challenge: a single VC can be reused and tracked across multiple interactions, potentially compromising user privacy. The VC passkey binding described above inherits the same problem, and this problem violates our unlinkability property. To address the linkability issue, two key changes are provided below:
1. Attribute-Specific VCs. Each identity attribute (e.g., full name, date of birth, address) includes its own separate VC. For example:
Full Name→Individual VC
Date of Birth (DOB)→Individual VC
Address→Individual VC

This allows users to share only the specific information required for a given interaction, providing granular control over their Personally Identifiable Information (PII).
2. Multiple VCs per Attribute. Issuers generate multiple VCs for each attribute, enabling users to present a unique, disposable VC for every engagement. This ensures privacy by preventing tracking across different interactions.

In some cases, this privacy preserving method can be applied to both unified architecture and separated architecture settings. The unified architecture is used as an example to discuss the method in this section. In some other cases, the privacy preserving method can be applied to the separated architecture in a similar way.

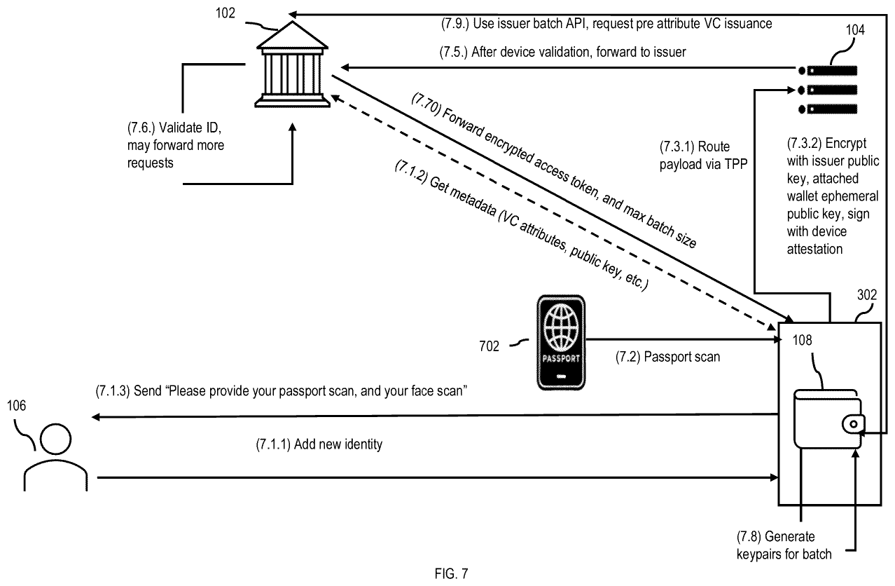

In some cases of a technical implementation, referring to FIG. 7, a flow diagram for VC batching is provided. The process of issuing privacy-preserving VCs includes the following computer operations:

### 1. Requesting a New Identity

At (7.1.1), the digital wallet 108 is activated and requests to add a new identity.

At (7.1.2) The wallet 108 retrieves metadata from the identity issuer 102 regarding the specific type of identity proof required.

At (7.1.3) The wallet 108, or some other application on the computing device, presents the user with a confirmation window, which includes instructions and a list of attributes to be issued (e.g., “age_over_18,” “age_over_21,” “vehicle_category_code”).

### 2. Authorization and Verification

At (7.2.1) The computing device 302, which has the wallet 018, authorizes the process using an appropriate method, such as photo identification, NFC scanning for a passport 702, or other Know Your Customer (KYC) mechanisms.

The scan result, along with an ephemeral wallet public key, is encrypted using the issuer's public key. Device attestation data is also included.

### 3. Platform-Assisted Request Handling

At (7.3.1) The encrypted payload is routed through platform infrastructure.

At (7.3.2) Platforms (e.g., operating systems) add device-specific attestation to the request and perform risk assessments to mitigate threats such as Distributed Denial-of-Service (DDoS) attacks or malicious payloads.

At (7.5) If deemed genuine and secure, the request is forwarded to the identity issuer 102, accompanied by a calculated risk score.

### 4. Issuer Verification and Token Generation

At (7.6), the identity issuer 102 decrypts the request and verifies the provided identification details. If additional information is required, the identity issuer 102 requests it, and the process repeats.

At (7.7), Upon successful verification, the identity issuer 102 generates a VC issuance access token, specifying the allowed batch size for attribute-specific VCs. This token is encrypted with the wallet's public key and sent back to the wallet.

### 5. VC Generation

At (7.8) The wallet decrypts the access token and generates a batch of public keys for the VCs within a secure enclave, if available.

At (7.9) the system uses the identity issuer's batch API, the wallet exchanges these public keys for attribute-specific VCs.

### 6. Completion

The wallet now stores a batch of disposable VCs, each tied to a specific identity attribute and ready for use in secure, privacy-preserving interactions.

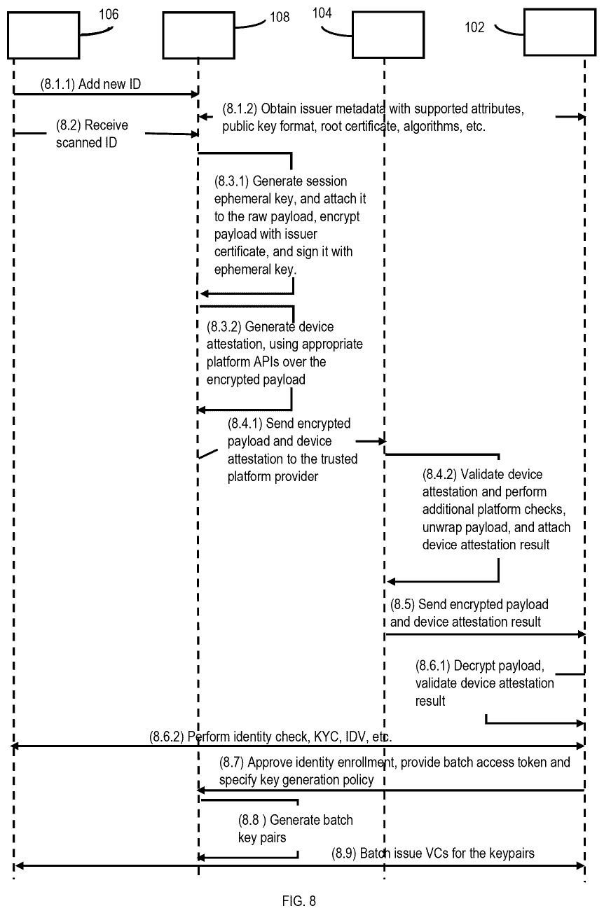

In some other cases, the process of VC batching is implemented according to the flow diagram of FIG. 8. At (8.1.1), new ID associated with the identity holder 106 is added to the wallet 108. At (8.1.2), the wallet 108 obtains issuer metadata with supported attributes, public key format, root certificate, algorithms, etc., from the identity issuer 102 via trusted platform provider 104. At (8.2), the wallet 108 receives scanned ID from the identity holder. At (8.3.1), the wallet 108 generates session ephemeral key, and attach it to the raw payload, encrypt payload with issuer certificate, and sign it with ephemeral key. At (8.3.2), the wallet 108 generates device attestation, using appropriate platform APIs over the encrypted payload. At (8.4.1), the wallet sends encrypted payload and device attestation to the trusted platform provider 104. At (8.4.2), the trusted platform provider 104 validates device attestation and performs additional platform checks, unwrap payload, and attach device attestation result. At (8.5), the trusted platform provider 104 send encrypted payload and device attestation result to the identity issuer 102. At (8.6.1), the identity issuer 102 decrypts payload and validates device attestation result. At (8.6.2), the system performs identity check, KYC, IDV, etc. At (8.7), the identity issuer 102 approves identity enrollment, provide batch access token and specify key generation policy. At (8.8), the wallet 108 generates batch key pairs. At (8.9) VCs for the keypairs are issued.

In some cases, when the wallet has multiple copies of the same identity attribute, the wallet will present one VC to one verifier and then burn it in order to ensure the single use of each VC. This single used VC avoids the linkability issue.

### Public Witness Network (Bidirectional Undeniability Property)

Public witness network is a publicly accessible database that stores the passkey and verified identity mapping. In some cases, publicly accessible means everyone can access the database but limited to the data related to this entity. For example, a user can only access the data belonging to this user, not other users.

For the separated architecture, this public witness network is a remediation of the phishing possibility. For the unified architecture, this public witness network is also important. It can serve as a witness in the event of dispute.

In some cases, this public witness network can work for both unified architecture and separated architecture. This network can be implemented by distributed database, blockchain, distributed ledger, etc. It can be a centralized solution but run by a trusted party. In some cases, the underlying technology does not affect the functionality of this network.

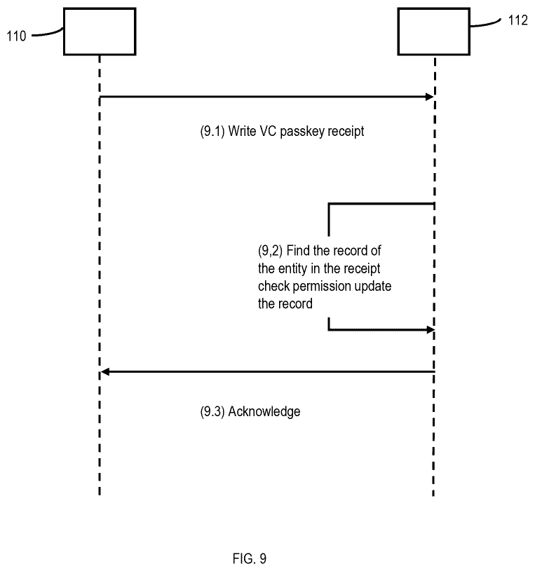

In some cases of a technical Implementation, referring to FIG. 9, a flow diagram shows the operations of a public witness network in communication with a verifier.

At (9.1), the identity verifier 110 writes the record to the public witness network 112.

At (9.2). The public witness network 112 can find the record of an entity in the receipt, check the permission, store the receipt, and update the record.

At (9.3) acknowledge is sent back to the identity verifier 110 from the public witness network 112.

### VC Synchronization Through Wallet Cloud (Synchronizability)

In some cases, the device bound identity wallet does not have this problem. But considering the existence of Web based wallets, it is a common scenario that VCs have to be synchronized across devices with the cloud assistant. For a Web based wallet, the browser doesn't have reliable local storage. Therefore, the VCs must be stored on the cloud (e.g., cloud computing environment) and synchronized to the local storage after the user signs in. Storing VCs on the cloud is facing one challenge that users don't trust the cloud.

To avoid the cloud abuse of the VCs stored on it, before VCs are uploaded to the cloud, in some cases VCs are encrypted by a cryptographic key which is kept secret from the cloud. In some cases, the account password is reused to derive the encryption key. In some cases, the cloud stores and/or has access to the password in order to authenticate the identity holder. In that case, the cloud can derive the decryption key of VCs, which is against the intended purpose. In some cases, augmented PAKE protocol is applied to enable the cloud authenticating the identity holder without knowing the password.

In some cases, this VC synchronization method can be applied to both unified architecture and separated architecture settings. We will use the unified architecture as an example to demonstrate how this method works in this section. It can be applied to separated architecture in a similar way.

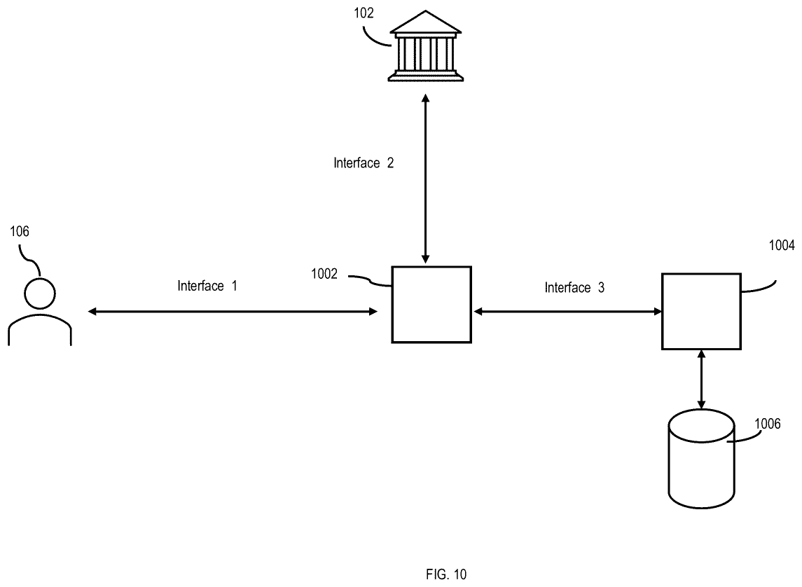

In some cases of a technical implementation, referring to FIG. 10, a system diagram is provided for executing VC synchronization. The system 1000 includes identity issuer 102, identity holder 104, identity wallet frontend (e.g., web) 1002 (also called “frontend”), identity wallet backend 1004 (also called “backend”), and identity database 1006. Interface 1 connects the identity holder 106 and the frontend 1002, which is connected to the identity issuer 102 via interface 2 and the backend 1004 via interface 3

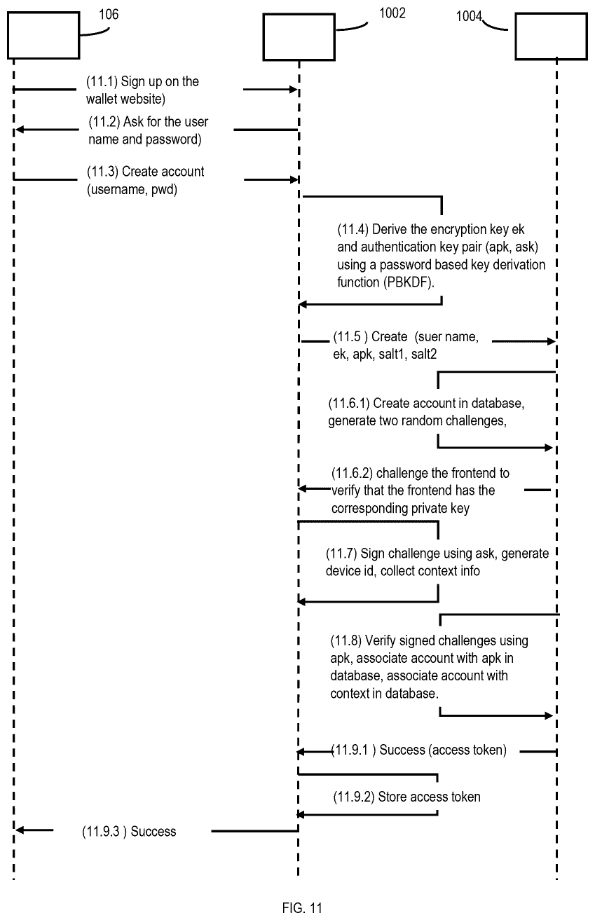

During the registration, the frontend derives the encryption key and authentication key pair using password. The public key of the authentication key pair is stored on the cloud for the authentication purpose. In some cases, the process for registration is implemented according to the flow diagram of FIG. 11. In some cases, the process includes:
(11.1). The identity holder (user) 106 signs up on the wallet website.
(11.2). The identity wallet frontend 1002 asks for the username and password.
(11.3). The identity holder 106 enters the username and password.
(11.4). The identity wallet frontend 1002 derives the encryption key ek and authentication key pair (apk, ask) using a password based key derivation function (PBKDF).
(11.5). The identity wallet frontend 1002 calls the backend API to create the account for the user and associate the authentication public key apk with the account.
(11.6.1). The identity wallet backend 1004 creates account in database and generates two random challenges.
(11.6.2). The identity wallet backend 1004 challenges the identity wallet frontend 100 to verify that the frontend has the corresponding private key.
(11.7). The identity wallet frontend 100 signs the challenge and returns to the identity wallet backend 1004.
(11.8). After the identity wallet backend 1004 verifies the signature using apk, the backend creates the record in the database.
(11.9.1). Once the verification successes, the access token is transmitted from the identity wallet backend 1004 to the identity wallet frontend 1002.
(11.9.2). The identity wallet frontend 1002 stores the access token.
(11.9.3). Once the verification successes, the access token is transmitted from the identity wallet frontend 1002 to the identity holder 106.

In some cases, one or more other multifactor authentication (MFA) authenticator(s) can be registered after this process.

Note that the key pair (apk, ask) is an example of augmented PAKE. Any augmented PAKE can be applied here.

The frontend should use Webcrypto API to derive the keys and set the exportable of ek and ask to false. To persist those sensitive keys, the CryptoKey objects should be directly stored in the IndexedDB.

The user is authenticated by augmented PAKE and, in some cases, the process includes:
1. The user signs in.
2. If the ek or (apk, ask) is missing, request password from the user.
3. Derive the keys and store them in IndexedDB.
4. Trigger the password authentication.
5. The backend sends a challenge to the frontend.
6. The frontend signs the challenge using ask.
7. The backend verifies the signature using apk.
8. The successful sign-in results in a valid access token and all encrypted VCs.

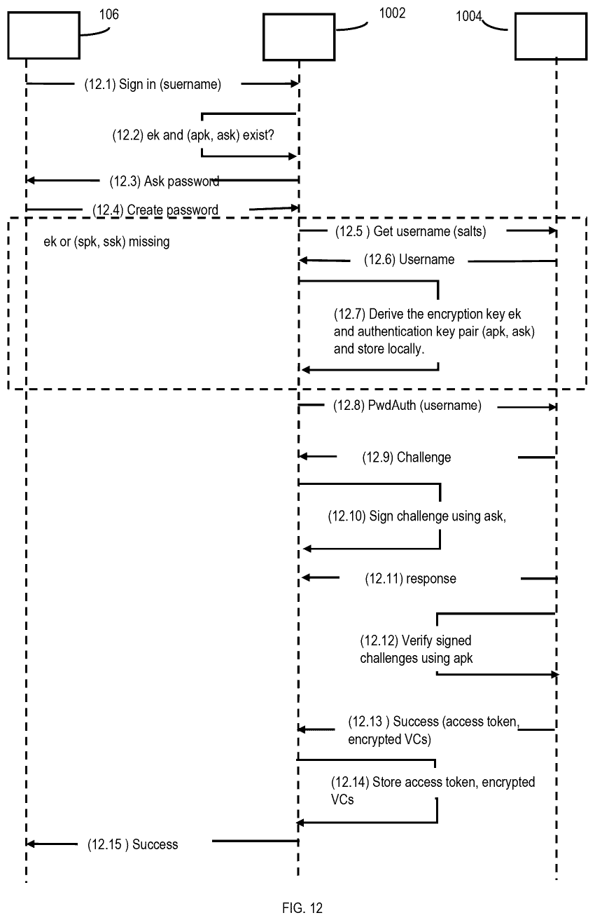

In some cases, the user authentication using augmented PAKE is implemented according to the flow diagram of FIG. 12. Using ask and apk to authenticate the user is an example of augmented PAKE. Any augmented PAKE can be applied here.

In some cases, the encrypted VCs are kept encrypted until it is used.

After the identity wallet frontend gets VCs for the identity holder through interface 2 (the process is discussed in FIG. 11, the frontend loads ek and encrypts the VCs before sending them to the cloud. Before using any VCs, the frontend loads ek and decrypts.

### VC Passkey Application: Identity Bound Digital Signature

When users register on a website, the website may ask the user to sign the user agreement after verifying the user's identity. In this case, this website is an identity verifier, content generator and content verifier. Content signing and verification are applications of the VC key discussed above. The content could be user agreement, consent, legal document, etc.

The process starts from content generator registration. In some cases, the wallet only allows registered content generators to present contents to the users, and the wallet verifies the origin of the content. The content generator first registers an account through the wallet dashboard. Then the content generator obtains an API key from the dashboard. Using the API key, the content generator can access the registration API.

In some cases, the wallet attaches required identity attributes VCs to the signed content. For example, the content could include official documents.

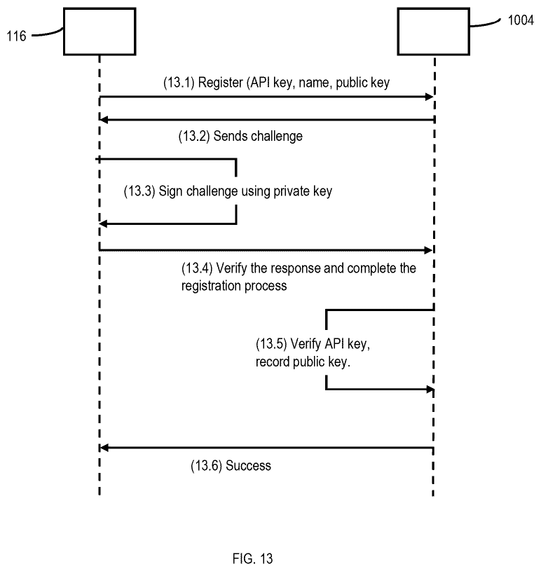

In some cases of a technical implementation, FIG. 13 shows a process for content generator registration. In some cases, the process includes:
(13.1). The content generator 116 calls the register API of the identity wallet backend 1004 with an API key. The public key is attached to the message.
(13.2). The identity wallet backend 1004 sends a challenge to the content generator 116 to prove that the content generator 116 has the corresponding private key.
(13.3). The content generator 116 signs the challenge and sends the response back.
(13.4). The identity wallet backend 1004 verifies the response and completes the registration process.
(13.5). The identity wallet backend 1004 verifies the API key and records public key.

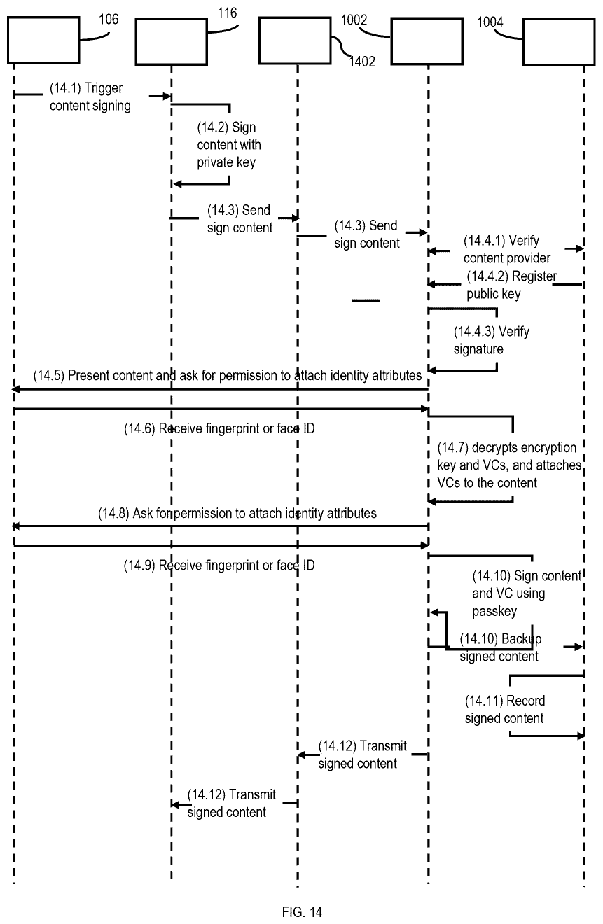

FIG. 14 shows a flow diagram for the content signing. In some cases, the signing process includes:
(14.1). The identity holder 106 (also called “user”) triggers the signing process.
(14.2). The content generator 116 generates the content and signs using its private key.
(14.3). The signed content (username, content provider, signed content, required identity attributes) is sent to the wallet through wallet SDK 1402.
(14.4.1). The wallet frontend 1002 verifies the content provider.
(14.4.2). The frontend 1002 requests the public key of this content provider from the wallet backend.
(14.4.3). Then the frontend 1002 verifies the signature of the content.
(14.5). The frontend 1002 presents content and asks for permission to use the required attributes.
(14.6). The frontend 1002 receives information (e.g., fingerprint or face ID) from the identity holder 106
(14.7). After the user approves, the frontend 1002 decrypts encryption key and one or more VCs, and attaches VCs to the content.
(14.8). The frontend 1002 asks for permission to use the passkey to sign.
(14.9). The frontend 1002 receives information (e.g., fingerprint or face ID) from the identity holder 106
(14.10). After approval, the content and the VCs are signed using the passkey.
(14.11). The signed content is backed up on the wallet cloud. Note that this step is optional. The purpose is to make the wallet a witness of the signature.

### Improvement of Identity Wallet

In this section, improvements to the identity wallet are discussed. The improvements increase the digital security (e.g., including digital trust) and flexibility to the identity wallet.

### Platform Generated VC Attributes

Trusted Platforms, such as Apple, Google, Samsung, etc., may offer a set of advanced features that are typically restricted from general users but accessible to exclusive partners. These features include:

### 1. On-Device Aggregated Location

This feature provides verifiers with aggregated location insights, such as: “In the last 30 days, the user has visited Denver, CO, and the Bay Area, CA.” It enables trusted partners, like banks, to gain reliable location assurance without compromising user privacy. This capability assists verifiers in making informed risk decisions. For instance, if a user is traveling to Thailand, the bank can request the platform_aggregated_location attribute. This allows the bank to promptly unlock the user's account or restrict card usage if the location data suggests potential fraud, thereby enhancing security.

### 2. Biometric Template Index

The Biometric Template Index acts as a unique reference ID for each stored biometric template, such as fingerprints or facial scans. Each distinct biometric verification method has a separate storage index, allowing the system to identify which biometric data is being used. This helps verifiers determine who is unlocking the wallet. For example, in cases of friendly fraud—such as unauthorized access by a child or an untrustworthy partner—the bank can detect mismatches in the biometric template index and block transactions, preventing misuse.

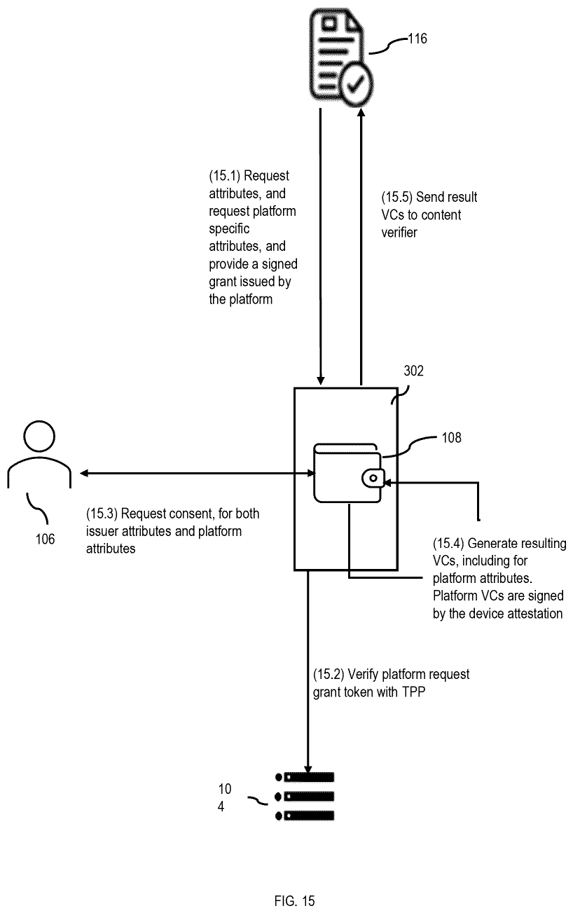

In some cases of a technical implementation, refer to FIG. 15 of a data flow diagram in relation to platform-generated VC attributes.

In some cases, the technical implementation of these features works as follows:

### (15.1). Verifier Request:

The identity verifier 116 calls the native VC (Verifiable Credential) issuing API, specifying both issuer attributes (e.g., name, dob) and platform attributes (e.g., biometric_template_index). Platform attribute requests include grant tokens issued by the platform.

### (15.2). Grant Token Validation:

The wallet 108 validates the provided grant tokens via the trusted platform provider 104.

### (15.3). User Consent:

The wallet presents a user consent form, allowing the identity holder 106 (user) to review and approve the data being shared.

### (15.4). VC Presentation Generation:

Upon user approval, the wallet 108 generates a VC presentation response for each requested attribute.

### (15.5). Response to Verifier:

The wallet 108 returns a list of successfully generated VCs to the identity verifier 116.

### (15.6). Verification and Risk Analysis:

The identity verifier 116 validates all received VCs and feeds the results into its risk engine to make an informed decision.

In some cases, this process provides secure, privacy-respecting access to advanced features, supporting high-quality risk assessments and fraud prevention.

### Cloud VC Wallet for Lower Assurance Scenarios

A cloud-based wallet is a secure digital platform designed to store and manage digital identities, payment credentials, and verifiable credentials (VCs) in the cloud. By leveraging cloud infrastructure, the cloud-based wallet provides real-time synchronization across multiple devices; in some cases, this provides seamless accessibility and convenience. Advanced cryptographic operations and integration with authentication methods such as biometrics or passkeys enhance both security and usability.

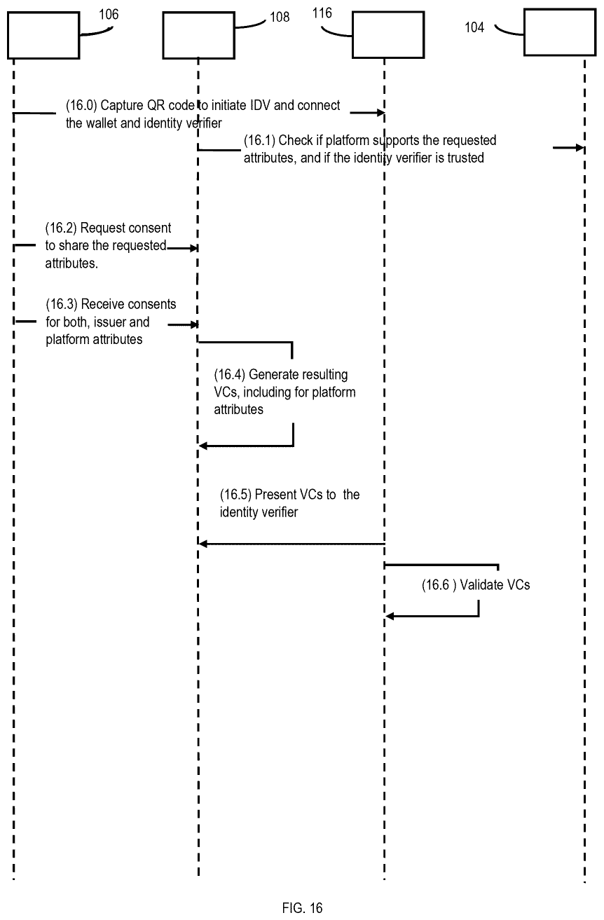

FIG. 16 shows a flow diagram for platform-generated VC attributes. In some cases, the process includes:
(16.0). The system capture QR code scanned by the identity holder to initiate IDV and connect the wallet 108 and identity verifier 116.
(16.1). The wallet 108 check if platform supports the requested attributes, and if the identity verifier is trusted.
(16.2), The wallet 108 requests consent from the identity holder 106 to share the requested attributes.
(16.3). The wallet receives consents for both, including issuer and platform attributes.
(16.4). The wallet 108 generate resulting VCs, including those for platform attributes.
(16.5). The wallet 108 present VCs to the identity verifier 116.
(16.6). The identity verifier 116 validates the VCs.

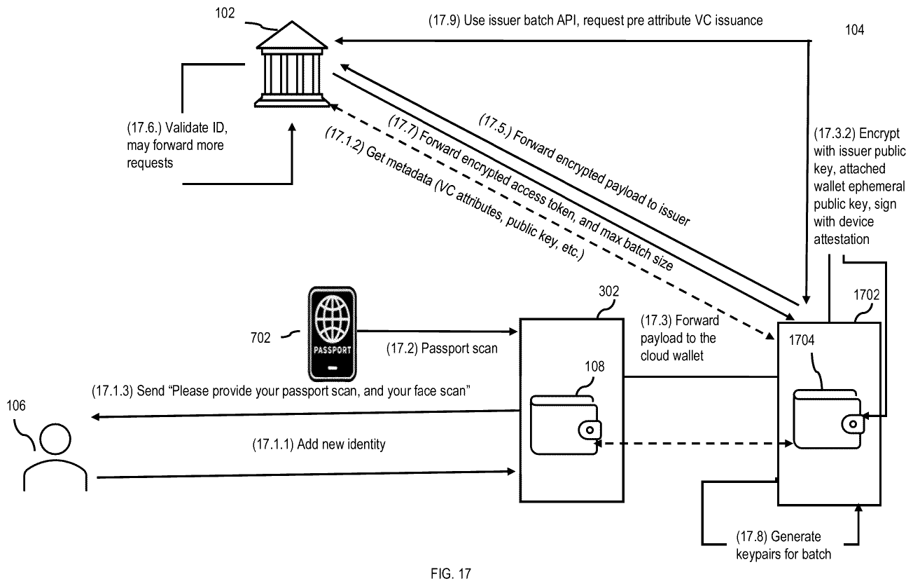

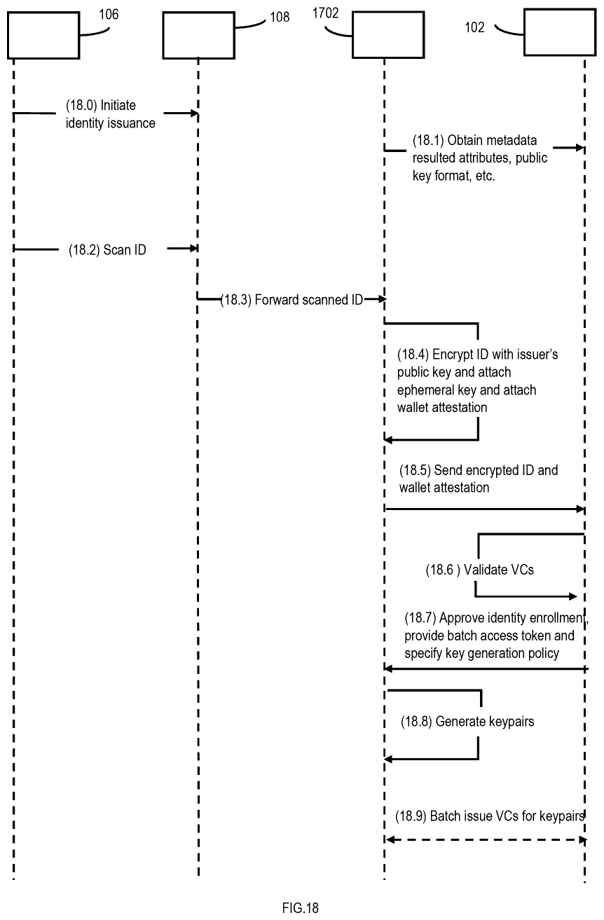

The below describes a technical Implementation with reference to FIG. 17, which shows a process for using a cloud-based wallet. Another process for using a cloud-based wallet is shown in FIG. 18. In some cases, the process includes:
1. Initiating Identity Addition
1.1 (17.1.1) The computing device 302 (operable by the identity holder 106) activating the wallet 108 and requests to add a new identity.
1.2 (17.1.2) The wallet 108 retrieves issuance metadata for the specific type of identity proof the user intends to add.
2. User Confirmation
2.1 (17.1.3) The wallet 108 presents a confirmation window with detailed instructions.
2.2 The user is shown a list of attributes associated with the identity type, such as: For a driver's license: “age_over_18,” “age_over_21,” “vehicle_category_code,” etc.
3. User Authorization
3.1 The computing device 302 completes authorization using the appropriate method, such as: Photo identification; Electronic NFC scanning of a passport; and/or Other Know Your Customer (KYC)-compliant means.
4. Scan and Encryption
4.1 (17.3) The scan results are securely forwarded to the cloud wallet 1702.
4.2 (17.4) The scan data, along with the wallet's ephemeral public key, is encrypted using the identity issuer's public key.
4.3 A Hardware Security Module (HSM) attestation is added to the payload.
5. Data Transmission to Issuer
5.1 (17.5) The encrypted payload is sent to the identity issuer 102.
5.2 (17.6) The identity issuer 102 decrypts the request and verifies the identity holder's identification.
6. Issuer Verification
6.1 If the identity issuer 102 requires additional information, the identity holder 106 is prompted to repeat the process.
6.2 Responsive to the identity issuer 102 determining it is satisfied, the identity issuer 102 returns an access token.
7. VC Issuance
7.1 After successful identity verification, the identity issuer 102 generates: a VC issuance access token; and information on allowed batch sizes per attribute VC.
7.2 (17.7) The data is encrypted with the wallet's public key and sent to the cloud wallet 1702.
8. Secure Key Generation
8.1 The wallet decrypts the access token.
8.2 (17.8) It generates VC public keys within a secure enclave (if available).
9. Batch API Exchange
9.1 (17.9) The wallet 108 uses the identity issuer's batch API to exchange the generated public keys for VCs.

In some cases, this structured process provides secure and efficient management of identity credentials while adhering to stringent privacy and security standards.

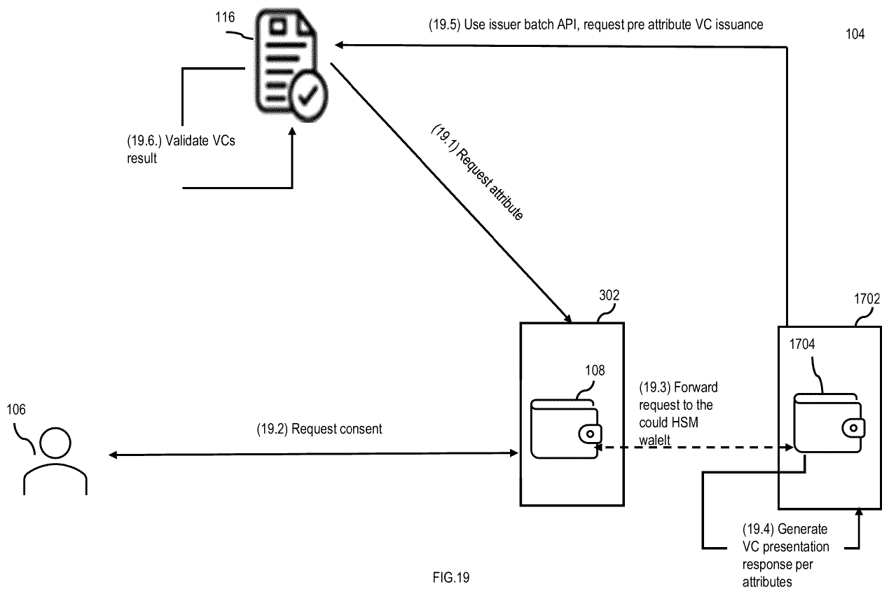

Referring to FIG. 19, a flow diagram is provided for using the cloud-based wallet. The process for using this system includes:
(19.1). Verifier Request: The verifier requests consent for a set of attributes from the user.
(19.2). User Consent: The user is prompted to review and approve the request.
(19.3). Forwarding to Cloud Hardware Security Module (HSM) Wallet: Upon user approval, the request is sent to the cloud HSM wallet. The wallet may require additional authentication from the user for security purposes.
(19.4). VC Generation and Usage: The cloud wallet generates Verifiable Credential (VC) presentations for each requested attribute and securely invalidates (burns) the used VCs.
(19.5). VC Transmission: The cloud wallet forwards the generated VCs to the verifier.
(19.6). Verifier Validation: The verifier validates the VCs and processes the results.

In some cases, this streamlined process provides secure, user-approved attribute sharing while maintaining data integrity and privacy.

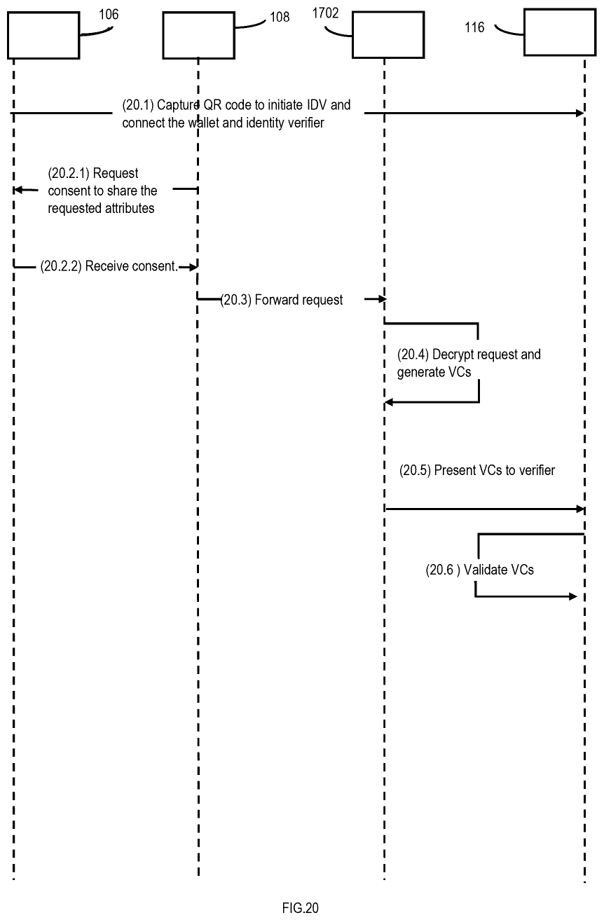

Referring to FIG. 20, another flow diagram is provided for using the cloud-based wallet.

In some cases, the systems, devices, and/or methods provided herein address the technical challenges associated with providing, using and storing a long-term usable verified identity. Two system architectures are provided to address these technical challenges: a unified architecture and a separated architecture. The systems, devices and/or methods described herein for VC passkey binding are provided for each architecture model. In some cases, the systems, devices, and/or methods address the technical challenges by providing: Unlinkability; Bidirectional undeniability; and Synchronizability.

In some cases, the systems, devices, and/or methods include an application of VC passkey, the identity bound digital signature. The application includes a content signing with an identity attached.

In some cases, since the identity wallet is used to manage the VCs or passkeys, in the unified architecture, improvements of the identity wallet were provided herein.

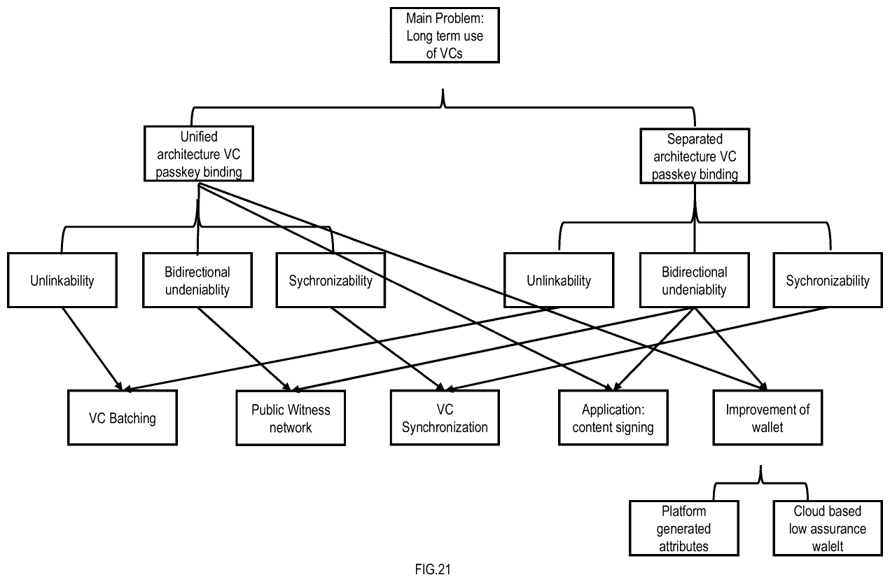

In some cases, the structure of the various systems and features are explained according to FIG. 21.

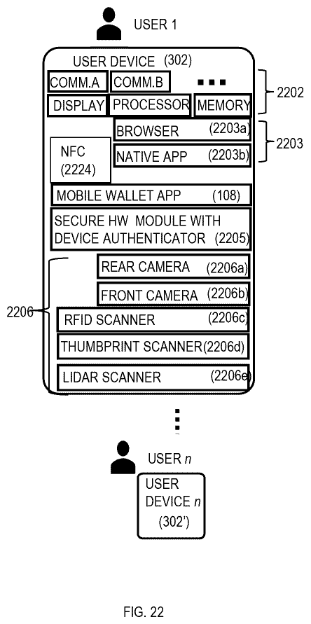

Turning to FIG. 22, the computing architecture includes one or more users (e.g., identity holder 1, identity holder 2) and their user devices 302. Examples of user devices include mobile devices, laptops, desktop computers, tablets, smart phones, etc. A user device 302 has a processor, memory, a communication module (e.g., for communicating via a cell network, WiFi, LAN, WAN, etc.), and a user interface (e.g., display screen, touch interface, keyboard, mouse, etc.), collectively referenced as 2202. In an example aspect, the user device 100 includes a browser 2203a, or a native application (also called an app) 2203b, or both. The browser or the native app, or both, are more generally herein referred to as the user agent 2203. The digital wallet, or wallet app, 108 is stored on the user device 302.

The user device also has secure module with a device authenticator (DA) 2205, which is used to store user-identifying data on the device a secure manner and to authenticate the user. The user device may also include a scanner 106, such as a camera, a thumbprint scanner, a heartrate monitor, a microphone for voice detection, etc. In an example aspect, the device authenticator 2205 includes a secure execution and secure storage environment, which can be implemented using one or more of: a Trusted Execution Environment (TEE); a secure element, a firewall; a software layer; a secure enclave; a Hardware Secure Module (HSM); etc. It will be appreciated that a TEE is a computing chip that, for example, exists on a processor device. It will be appreciated that a HSM is a separated computing appliance. Authentication data about a user can be stored in the device authenticator. The authentication data about the user, for example, includes a device authentication private key (also referred to as a DA private key) associated with the user and the device authenticator 2205 of the device 302. In an example aspect of using a FIDO protocol, the DA private key is known as a FIDO private key. The device authenticator may also store other data, including, but not limited to: biometric authentication data, passwords, security codes, name, address, account numbers (e.g., like a primary account number (PAN), driver's license number, etc.), age, date of birth, citizenship, credentials, etc.

The device authenticator, for example, interacts with a scanner 2206 to obtain identifying data about the user, and compares the scanned identifying data about the user with stored identifying data about the user. For example, the identifying data about the user is biometric authentication data, including and not limited to one or more of: fingerprint scan, eye scan, facial recognition, voice recognition, heartbeat or pulse monitoring, DNA sampling, body temperature, etc. The scanner 106 includes one or more sensors that can capture the biometric authentication data. Examples of scanners include a rear camera 2206a, a front camera 2206b, an RFID scanner 2206c, a thumbprint scanner 2206d, and a light detection and ranging (LIDAR) scanner 2206e.

In other words, the device authenticator stores first biometric authentication data, such as during a setup process. To verify a transaction, the scanner is used to obtain the user input verification, which comprises second biometric authentication data. The device authenticator compares the second biometric authentication data with the first biometric data, which is already stored on the device authenticator. A successful match of the data leads to the device authenticator verifying transaction data. In some cases, the device authenticator is used as part FIDO authentication process.

In some example embodiments, the processes described herein use a scanner 2206. In other example embodiments, the processes described herein do not use a scanner 106, and the identifying data about the user is submitted through other interfaces. It will also be appreciated that the identifying information about the user can data that is not biometric in nature.

In an example embodiment, the device authenticator 2205 and the scanner 2206 are built into the user device 302.

In another example embodiment, the device authenticator 2205 and the scanner 2206 are part of an external authenticator device 302′. The user device 302 and the external authenticator device 302′ are in data communication with each other. For example, the external authenticator device 302′ is connected to the user device 302 via a wire or some other electrical connection (e.g., universal serial bus (USB)). In another example, the external authenticator device 302′ is connected to the user device 302 via wireless communication. Examples of wireless communication include the Bluetooth, Near Field Communication, and WiFi. Example embodiments of an external authenticator device 302′ include a smart watch, a USB key, a dongle, and a smart phone.

The user device 302, in some cases, also includes an NFC module 2224 to, for example, facilitate contactless payments using the digital wallet 108.

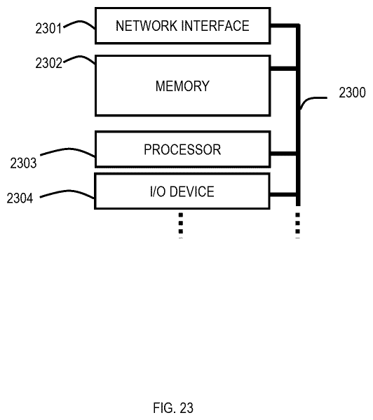

As shown in FIG. 23, a server, such as the identity issuer 102, identity verifier 110, trusted platform 104, content generator 116, and content verifier 118, includes a network interface 2301, memory 2302, one or more processors 2303, memory, and, in some cases, an input/output device 2304. These components are in data communication together, for example, using a data bus 2300. A server also includes software and other logic modules for storing data and executing instructions.

Various systems or processes have been described to provide examples of embodiments of the claimed subject matter. No such example embodiment described limits any claim and any claim may cover processes or systems that differ from those described. The claims are not limited to systems or processes having all the features of any one system or process described above or to features common to multiple or all the systems or processes described above. It is possible that a system or process described above is not an embodiment of any exclusive right granted by issuance of this patent application. Any subject matter described above and for which an exclusive right is not granted by issuance of this patent application may be the subject matter of another protective instrument, for example, a continuing patent application, and the applicants, inventors or owners do not intend to abandon, disclaim or dedicate to the public any such subject matter by its disclosure in this document.

For simplicity and clarity of illustration, reference numerals may be repeated among the figures to indicate corresponding or analogous elements. In addition, numerous specific details are set forth to provide a thorough understanding of the subject matter described herein. However, it will be understood by those of ordinary skill in the art that the subject matter described herein may be practiced without these specific details. In other instances, well-known methods, procedures, and components have not been described in detail so as not to obscure the subject matter described herein.

The terms “coupled” or “coupling” as used herein can have several different meanings depending in the context in which these terms are used. For example, the terms coupled or coupling can have a mechanical, electrical or communicative connotation. For example, as used herein, the terms coupled or coupling can indicate that two elements or devices are directly connected to one another or connected to one another through one or more intermediate elements or devices via an electrical element, electrical signal, or a mechanical element depending on the particular context. Furthermore, the term “operatively coupled” may be used to indicate that an element or device can electrically, optically, or wirelessly send data to another element or device as well as receive data from another element or device.

As used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

Terms of degree such as “substantially”, “about”, and “approximately” as used herein mean a reasonable amount of deviation of the modified term such that the result is not significantly changed. These terms of degree may also be construed as including a deviation of the modified term if this deviation would not negate the meaning of the term it modifies.

Any recitation of numerical ranges by endpoints herein includes all numbers and fractions subsumed within that range (e.g., 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the result is not significantly changed.

The systems and methods described herein may be implemented as a combination of hardware or software. In some cases, the systems and methods described herein may be implemented, at least in part, by using one or more computer programs, executing on one or more programmable devices including at least one processing element, and a data storage element (including volatile and non-volatile memory and/or storage elements). These systems may also have at least one input device (e.g. a pushbutton keyboard, mouse, a touchscreen, and the like), and at least one output device (e.g. a display screen, a printer, a wireless radio, and the like) depending on the nature of the device. Further, in some examples, one or more of the systems and methods described herein may be implemented in or as part of a distributed or cloud-based computing system having multiple computing components distributed across a computing network. For example, the distributed or cloud-based computing system May correspond to a private distributed or cloud-based computing cluster that is associated with an organization. Additionally, or alternatively, the distributed or cloud-based computing system be a publicly accessible, distributed or cloud-based computing cluster, such as a computing cluster maintained by Microsoft Azure™, Amazon Web Services™, Google Cloud™, or another third-party provider. In some instances, the distributed computing components of the distributed or cloud-based computing system may be configured to implement one or more parallelized, fault-tolerant distributed computing and analytical processes, such as processes provisioned by an Apache Spark™ distributed, cluster-computing framework or a Databricks™ analytical platform. Further, and in addition to the CPUs described herein, the distributed computing components may also include one or more graphics processing units (GPUs) capable of processing thousands of operations (e.g., vector operations) in a single clock cycle, and additionally, or alternatively, one or more tensor processing units (TPUs) capable of processing hundreds of thousands of operations (e.g., matrix operations) in a single clock cycle.

Some elements that are used to implement at least part of the systems, methods, and devices described herein may be implemented via software that is written in a high-level procedural language such as object-oriented programming language. Accordingly, the program code may be written in any suitable programming language such as Python or Java, for example. Alternatively, or in addition thereto, some of these elements implemented via software may be written in assembly language, machine language or firmware as needed. In either case, the language may be a compiled or interpreted language.

At least some of these software programs may be stored on a storage media (e.g., a computer readable medium such as, but not limited to, read-only memory, magnetic disk, optical disc) or a device that is readable by a general or special purpose programmable device. The software program code, when read by the programmable device, configures the programmable device to operate in a new, specific, and predefined manner to perform at least one of the methods described herein.

Furthermore, at least some of the programs associated with the systems and methods described herein may be capable of being distributed in a computer program product including a computer readable medium that bears computer usable instructions for one or more processors. The medium may be provided in various forms, including non-transitory forms such as, but not limited to, one or more diskettes, compact disks, tapes, chips, and magnetic and electronic storage. Alternatively, the medium may be transitory in nature such as, but not limited to, wire-line transmissions, satellite transmissions, internet transmissions (e.g., downloads), media, digital and analog signals, and the like. The computer usable instructions may also be in various formats, including compiled and non-compiled code.

While the above description provides examples of one or more processes or systems, it will be appreciated that other processes or systems may be within the scope of the accompanying claims.

To the extent any amendments, characterizations, or other assertions previously made (in this or in any related patent applications or patents, including any parent, sibling, or child) with respect to any art, prior or otherwise, could be construed as a disclaimer of any subject matter supported by the present disclosure of this application, Applicant hereby rescinds and retracts such disclaimer. Applicant also respectfully submits that any prior art previously considered in any related patent applications or patents, including any parent, sibling, or child, may need to be revisited.

What is claimed is:

1. A system comprising:
a user device, an identity issuer server, an identity verification server, and a content generator server;
the identity issuer server configured to issue a batch of verification credentials (VCs) for an identity holder to an identity wallet application installed on the user device;
the identity wallet application configured to store the batch of VCs, respectively bind each VC in the batch of VCs with a given device-bound passkey from a plurality of device-bound passkeys, generate selective disclosures via the content generator server, and transmit the batch of VCs, as a plurality of VC presentations, to the identity verification server, wherein the identity wallet application transmits the plurality of VC presentations responsive to receiving a consent action from the identity holder;
the identity verification server configured to request and validate the plurality of VC presentations, and, responsive to validating the plurality of VC presentations, register the plurality of device-bound passkeys respectively bound to the batch of VCs to generate a plurality of registered passkeys;
wherein after generating the plurality of registered passkeys, the identity verification server is further configured to authenticate the identity holder using one or more of the registered passkeys; and
the content generator server configured to prepare digital content and transmit the digital content to the identity wallet application; and
wherein, after receiving the digital content, the identity wallet application is configured to further attach one or more VCs of the batch of VCs to the digital content and digitally sign a combination of the attached one or more VCs and the digital content using one or more of the plurality of passkeys corresponding to the attached one or more VCs.

2. The system of claim 1, wherein the identity verification server is a subsystem comprising a verifier module and a Fast Identity Online (FIDO) server, the verifier is configured to generate and transmit VC presentation requests, and the FIDO server is configured to store and manage one or more public keys.

3. The system of claim 1, wherein the user device comprises biometric authentication hardware to authenticate the identity holder and release access to one or more private keys for signing, the one or more private keys corresponding to the one or more public keys.

4. The system of claim 1 further comprises a public witness network configured to store mappings of VCs and passkeys in distributed database.

5. The system of claim 4, wherein the public witness network comprises distributed databases or a blockchain network of databases.

6. The system of claim 1, wherein presenting the VCs is triggered by at least one of: scanning a QR code, near-field communication (NFC), and Bluetooth.

7. The system of claim 1, wherein the identity wallet application is further configured to generate a new device-bound passkey responsive to detecting that no match is found in a list of known passkeys.

8. The system of claim 1, wherein the identity wallet application is further configured to manage both the VCs and the passkeys.

9. The system of claim 1, wherein the identity wallet application is further configured to manage the VCs, while a passkey manager is configured to manage the passkeys.

10. A system comprising:
a wallet server, an identity issuer server, an identity verification server, and a content generator server;
the identity issuer server configured to issue a batch of VCs, for an identity holder, to a cloud-based identity wallet application on the wallet server, the cloud-based identity wallet application accessible through a user device of the identity holder;
the cloud-based identity wallet application configured to retrieve insurance metadata, respectively bind each VC in the batch of VCs with a passkey from a plurality of passkeys, generate selective disclosures via the content generator server, and transmit the batch of VCs, as a plurality of VC presentations, to the identity verification server, wherein the identity wallet application transmits the plurality of VC presentations responsive to receiving a consent action from the identity holder;
the identity verification server configured to request and validate the plurality of VC presentations, and, responsive to validating the plurality of VC presentations, register the plurality of passkeys respectively bound to the batch of VCs to generate a plurality of registered passkeys;
wherein after generating the plurality of registered passkeys, the identity verification server is further configured to authenticate the identity holder using one or more of the registered passkeys;
the content generator server configured to prepare digital content and transmit the digital content to the identity wallet application; and
wherein, after receiving the digital content, the identity wallet application is configured to further attach one or more VCs of the batch of VCs to the digital content and digitally sign a combination of the attached one or more VCs and the digital content using one or more of the plurality of passkeys corresponding to the attached one or more VCs.

11. The system of claim 10, wherein the identity verification server comprising a verifier module and a FIDO server, the verifier module is configured to generate and transmit VC presentation requests, and the FIDO server is configured to store and manage one or more public keys.

12. The system of 11, wherein the user device comprises biometric authentication hardware to authenticate the identity holder and release access to one or more private keys for signing, the one or more private keys corresponding to the one or more public keys.

13. The system of claim 10, wherein the system further comprises a public witness network configured to store mappings of VCs and passkeys in distributed database.

14. The system of claim 13, wherein the public witness network comprises distributed databases or a blockchain of network.

15. The system of claim 10, wherein presenting the VCs is triggered by any one of: scanning a QR code, NFC, and Bluetooth.

16. The system of claim 10, wherein the identity wallet application is further configured to generate a new device-bound passkey responsive to detecting that no match is found in a list of known passkeys.

17. The system of claim 10, wherein the identity wallet application is further configured to manage both the VCs and the passkeys.

18. The system of 10, wherein the identity wallet application is further configured to manage the batch of VCs, while a passkey manager is configured to manage the passkeys.

19. A computing device comprising: a processor, a display, memory and a communication module; the memory storing a software application for an identity wallet; wherein the software application is configured to: display a credential issuance request and a VC presentation request in response to an external data call; generate a VC presentation; execute a passkey selection to select an existing passkey that is bound to the computing device or to generate a new passkey that is bound to the computing device; append the existing passkey or the new passkey to the VC presentation request and is signed by a corresponding VC; and send the VC presentation in response to the external data call.
